(19) United States
(12) Patent Application Publication
(10) Pub. No.: US 2026/0289246 A1
(43) Pub. Date: Sep. 24, 2026

(54) SYSTEM

(71) Applicant: SoftBank Group Corp., Tokyo (JP)

(72) Inventor: Hiroshi TSURUMA, Tokyo (JP)

(73) Assignee: SoftBank Group Corp., Tokyo (JP)

(21) Appl. No.: 19/560,198

(22) Filed: Mar. 9, 2026

(30) Foreign Application Priority Data
Mar. 19, 2025 (JP) 2025-044889

(51) Int. Cl. G06N 3/0464; G06F 40/30; G06N 3/044; G06N 3/048

(52) U.S. Cl. CPC G06N 3/0464; G06F 40/30; G06N 3/044; G06N 3/048

(57) ABSTRACT

A system includes a processor that is configured to use a sensor device to collect behavior information and utterance information of a user, analyze the collected information by using a natural language processing technique, and input a prompt sentence to a generative AI model based on an analysis result of the collected information, and estimate and determine a worry or a task of the user by using an output of the generative AI model.

### CROSS-REFERENCE TO RELATED APPLICATION

This application is based on and claims priority under 35 USC 119 from Japanese Patent Application No. 2025-044889 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional support systems for users' worries and tasks rely heavily on explicit user input such as manual questionnaires or simple keyword searches, and therefore fail to accurately grasp the user's true concerns, intentions, and contextual situation. As a result, such systems are often unable to provide appropriate and timely solutions that reflect the user's actual state. In addition, even when behavior information or utterance information is collected, conventional systems typically perform only simple pattern matching or rule-based analysis, which is insufficient for extracting deep semantic meaning and latent issues behind the user's expressions. Furthermore, existing approaches do not effectively leverage generative AI models together with natural language processing to transform unstructured behavior information and utterance information into high-quality prompts and to derive precise estimations and determinations of the user's worries and tasks. Therefore, there is a need for a system that can automatically collect user behavior information and utterance information, perform advanced analysis using natural language processing, and cooperate with a generative AI model to accurately estimate and determine the user's worries and tasks and thereby support appropriate solution provision and feedback.

### SUMMARY

In order to solve the above-described problems, a system according to one aspect of the present invention comprises a processor, wherein the processor is configured to use a sensor device to collect behavior information and utterance information of a user, analyze the collected information by using a natural language processing technique, and input a prompt sentence to a generative AI model based on an analysis result of the collected information, and estimate and determine a worry or a task of the user by using an output of the generative AI model. In addition, the processor may be configured to provide an optimal solution for the user based on an estimation and determination result obtained from the generative AI model, so that the user can receive personalized support corresponding to the user's actual worries and tasks. Furthermore, the processor may be configured to monitor an execution status of the solution and provide feedback to the user together with the analysis result, thereby enabling continuous improvement of the solution and adaptive support according to changes in the user's behavior and state. Through these means, the system can accurately understand the user's concerns from real-world behavior information and utterance information and can provide highly relevant and effective assistance.

The term “processor” refers to one or more hardware computing elements, such as a central processing unit (CPU), a microprocessor, a microcontroller, a digital signal processor (DSP), or any combination thereof, configured to execute instructions and perform the operations described in the present specification and claims.

The term “sensor device” refers to any hardware device or combination of devices configured to detect, measure, or capture physical, physiological, environmental, or behavioral phenomena related to a user, including but not limited to motion sensors, accelerometers, gyroscopes, microphones, cameras, wearable sensors, and other input devices capable of generating behavior information or utterance information.

The term “behavior information” refers to data representing actions, activities, or states of a user, which are acquired through the sensor device, including but not limited to movement patterns, location histories, usage logs of applications or services, activity levels, and other observable behaviors in physical or digital environments.

The term “utterance information” refers to data representing spoken or written expressions of a user, including but not limited to voice data captured by a microphone, text data entered by the user, messages posted on social media, chat logs, and any other linguistic expressions that can be analyzed using natural language processing techniques.

The term “natural language processing technique” refers to any algorithm, model, or computational method for processing, analyzing, or understanding human language in text or speech form, including but not limited to tokenization, syntactic analysis, semantic analysis, sentiment analysis, intent detection, classification, and feature extraction.

The term “analysis result” refers to information obtained by applying a natural language processing technique to the collected behavior information and utterance information, including but not limited to extracted features, categories, intents, sentiments, topics, or other intermediate or final outputs used to generate a prompt sentence or to derive an estimation and determination of a user's worry or task.

The term “prompt sentence” refers to a text or textual input sequence generated or composed based on the analysis result, which is formatted and adapted to be supplied as an input to a generative AI model so as to cause the generative AI model to output information useful for estimating and determining a user's worry or task.

The term “generative AI model” refers to a machine learning model, such as a neural network-based language model, configured to generate text or other content in response to a prompt sentence, and capable of producing responses, suggestions, or inferences that are used to estimate and determine the user's worry or task.

The term “output of the generative AI model” refers to the content generated by the generative AI model in response to the prompt sentence, including but not limited to textual responses, inferred explanations, or structured data that serve as a basis for estimating and determining the user's worry or task.

The term “worry or task of the user” refers to a problem, issue, concern, challenge, objective, or goal of the user, explicitly or implicitly indicated in the behavior information or utterance information, which is inferred, estimated, or determined by using the output of the generative AI model.

The term “optimal solution” refers to information, advice, an action plan, a service, or a combination thereof that is selected or generated based on the estimation and determination result of the user's worry or task, and that is considered most suitable or beneficial for addressing the user's specific situation according to predefined criteria or learned models.

The term “execution status of the solution” refers to information indicating how the user has implemented, followed, or progressed with respect to the provided optimal solution, including but not limited to completion status, degree of adherence, measured performance metrics, timestamps of actions, and other indicators of implementation.

The term “feedback” refers to information provided to the user based on the analysis result and the execution status of the solution, including but not limited to evaluations, guidance, advice, encouragement, corrections, or updated instructions intended to support, improve, or adapt the user's behavior or the applied solution.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

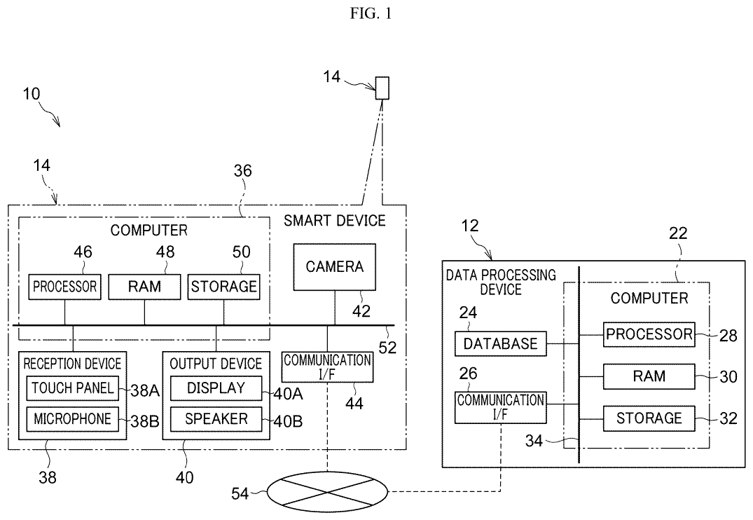

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

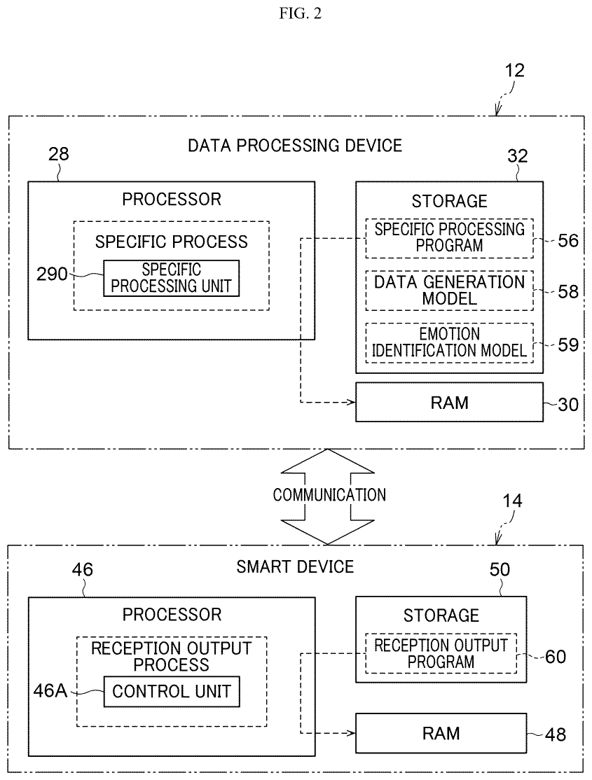

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented support systems for users' concerns and problems typically rely on single-modal inputs, such as isolated text messages or simple questionnaires, and use fixed, rule-based logic to infer user states. Such systems face multiple technical limitations in terms of data acquisition, data integration, model utilization, and adaptive control of outputs.

First, in existing architectures, behavior information (for example, motion and device usage patterns), utterance information (for example, spoken or written content), and external posting information (for example, social network posts) are processed in separate pipelines without coherent time-series integration. This results in fragmented data representations that make it difficult for a processor to generate a unified and contextually accurate model of a user's state. As a consequence, the system's ability to infer user concerns, problems, and desires is technically limited, leading to low accuracy and unstable performance across different contexts and time periods.

Second, in many systems that employ machine learning, generative models or large language models are treated as opaque components. The prompt sentences used to query these models are often static or manually designed, without systematic adaptation to evolving user data. Because the prompt content and structure are not coupled to integrated, multimodal user state information, the utilization efficiency of generative AI models is low. The processor cannot fully exploit the model's representational power, and cannot maintain consistent quality of inference and advice generation over long-term user interactions.

Third, known systems typically lack a mechanism to store and learn from time-series data of integrated event information, emotion information, intention information, expression state information, and behavior state information. Without such a learning mechanism, the processor cannot refine the weighting and threshold values used for estimating and determining user concerns, problems, and desires, and cannot automatically adjust generation of solution information. This absence of adaptive feedback at the system architecture level leads to degraded robustness, higher computational overhead due to repeated ad hoc processing, and poor scalability when dealing with many users over extended periods.

Therefore, there is a need for an improved computer-implemented system that (i) acquires and preprocesses multimodal user data into integrated event information, (ii) generates and controls prompt sentences in a structured, adaptive manner for a generative AI model, and (iii) learns from time-series state transition information to update parameters for estimation, determination, and solution generation. Such a system should technically improve the way processors orchestrate data acquisition, model invocation, and feedback control, thereby enhancing accuracy, efficiency, and stability of user state inference and personalized solution generation.

The specific processing by the specific processing unit 290 of the data processing device 12 in Example 1 is realized by the following means.

The present invention provides a server comprising a processor configured to acquire, by using an information acquisition device and a communication control device, behavior information and utterance information of a user from a user terminal, acquire posting information from an external information providing device, preprocess the acquired information by converting audio information into character information, extracting feature amounts from image information, performing text normalization and tokenization, and integrating the behavior information, the utterance information, and the posting information into integrated event information for each user, generate a first prompt sentence based on character information included in the integrated event information and input the first prompt sentence into a generative information processing model to obtain emotion information and intention information, input the feature amounts and state information into a discrimination model to obtain expression state information and behavior state information, integrate the emotion information, the intention information, the expression state information, and the behavior state information to estimate and determine concern information, problem information, and desire information of the user, generate a second prompt sentence based on the concern information, the problem information, and the desire information and input the second prompt sentence into the generative information processing model to generate response information including solution information individually optimized for the user, transmit the response information to the user terminal via a notification communication device and cause display of the solution information through a display control device, record presentation results and selection operation information of the user as behavior history information, sequentially update contents and structures of the first prompt sentence and the second prompt sentence based on the behavior history information and the integrated event information such that the solution information reflects long-term state changes of the user, and store the integrated event information, the emotion information, the intention information, the expression state information, and the behavior state information as time-series data, execute a learning process using the time-series data to learn state transition information of the user, and update weighting and threshold values used for the estimation and determination of the concern information, the problem information, and the desire information and for generation of the solution information based on a result of the learning process. This enables an improved computer-implemented mechanism for multimodal data integration, adaptive prompt control for a generative AI model, and time-series learning of user state transitions, thereby enhancing the technical performance, accuracy, and robustness of user state inference and personalized solution generation by the server.

The term “behavior information” refers to information indicating physical or digital activities of a user, including but not limited to motion patterns, device operation patterns, and usage context acquired from a user terminal or external devices.

The term “utterance information” refers to information representing spoken or written expressions of a user, including audio data, transcribed text, and text messages input or transmitted by the user.

The term “state information” refers to information indicating a status of a user or a user terminal at a given time, including positional information, activity level, device status, and environmental conditions.

The term “audio information” refers to information representing sound signals, including voice signals of a user captured by a sound input device and any other acoustic data relevant to user interaction.

The term “image information” refers to information representing visual data, including still images and video frames capturing a user, a user's surroundings, or screen content of a user terminal.

The term “character information” refers to information expressed in symbolic text form, including letters, numerals, symbols, and encoded natural language strings obtained from user inputs or recognition processes.

The term “posting information” refers to information representing content posted by a user to an external service, including text posts, comments, reactions, and associated metadata obtained via a communication interface.

The term “user terminal” refers to an electronic apparatus operated by a user, including portable computing devices, stationary computing devices, and other network-enabled terminals capable of input, output, and communication.

The term “external information providing device” refers to an information processing system or service outside the server, including network services, platforms, and application servers that store or distribute user-generated content.

The term “information acquisition device” refers to a functional unit or hardware and software combination configured to receive, read, or capture data from a user terminal, sensors, or external services.

The term “communication control device” refers to a functional unit or hardware and software combination configured to manage data transmission and reception between the server, the user terminal, and external systems using communication protocols.

The term “speech recognition processing device” refers to a functional unit or processing module configured to convert audio information into character information by applying automatic speech recognition algorithms.

The term “image processing device” refers to a functional unit or processing module configured to perform operations on image information, including detection, segmentation, normalization, and enhancement of visual features.

The term “feature amount” refers to numerical or symbolic data extracted from raw input information, representing discriminative characteristics such as facial expressions, body postures, or other patterns suitable for machine analysis.

The term “feature amount extraction device” refers to a functional unit or processing module configured to derive feature amounts from raw data such as image information, audio information, or sensor readings.

The term “character string formatting device” refers to a functional unit or processing module configured to normalize, clean, and structurally adjust character information, including removal of unnecessary elements and formatting of text.

The term “language processing device” refers to a functional unit or processing module configured to perform natural language processing on character information, including tokenization, part-of-speech analysis, and linguistic normalization.

The term “integrated event information” refers to structured information units generated by temporally aligning and combining behavior information, utterance information, posting information, and related metadata for each user.

The term “semantic analysis language model” refers to a statistical or neural model configured to analyze character information and output semantic attributes such as topics, intentions, and emotions.

The term “prompt sentence” refers to a sequence of text or structured instructions formulated to be input into a generative information processing model in order to induce a desired type of processing or output.

The term “generative information processing model” refers to an information processing model, including a generative AI model or language model, configured to generate outputs such as texts, labels, or structured data in response to input information or prompt sentences. The term “emotion information” refers to information representing an estimated emotional state of a user, including categories such as happiness, sadness, fatigue, or stress, and optionally associated confidence values or intensities.

The term “intention information” refers to information representing an estimated purpose, goal, or communicative intent of a user inferred from behavior information, utterance information, and posting information.

The term “discrimination model” refers to a model or algorithm configured to classify or regress input feature amounts and state information into categories or values such as expression states and behavior states.

The term “expression state information” refers to information representing a user's facial or bodily expression state, including classifications such as tired, stressed, neutral, or energetic, derived from visual feature amounts.

The term “behavior state information” refers to information representing an interpreted state of user activity, such as active, sedentary, resting, or anomalous, derived from behavior information and feature amounts.

The term “information integration device” refers to a functional unit or processing module configured to combine multiple types of information, including emotion information, intention information, expression state information, and behavior state information, into a unified representation.

The term “concern information” refers to information representing an inferred area of worry or issue of a user, such as fatigue, work-related stress, or interpersonal problems, deduced from integrated user state information.

The term “problem information” refers to information representing a specific difficulty or situation negatively affecting a user, such as overwork, lack of sleep, or time management issues, identified through estimation and determination processes.

The term “desire information” refers to information representing an inferred wish, goal, or preference of a user, such as wanting rest, improvement of performance, or better relationships, inferred from multimodal data.

The term “response information” refers to information generated for presentation to a user, including solution information, explanatory content, and optional follow-up suggestions.

The term “solution information” refers to information representing proposed actions, recommendations, or strategies intended to address the concern information, problem information, or desire information of a user.

The term “notification communication device” refers to a functional unit or processing module configured to send response information or notifications from the server to a user terminal using a communication network.

The term “display control device” refers to a functional unit or processing module configured to control presentation of information on a display of a user terminal, including layout, timing, and interaction elements.

The term “presentation result” refers to information indicating how response information has been presented or consumed, including whether a notification was shown, opened, or dismissed by a user.

The term “selection operation information” refers to information indicating explicit choices or interactions performed by a user in response to presented information, such as selecting an option, starting an exercise, or requesting more details.

The term “behavior history information” refers to information representing a time-series record of user actions, presentation results, and selection operation information accumulated over multiple interactions.

The term “time-series data” refers to data in which individual records are associated with temporal indices, enabling analysis of sequences, trends, and state transitions over time. The term “state transition information” refers to information describing changes in user states, including transitions between different emotional, behavioral, and contextual conditions over time.

The term “learning process” refers to a computational procedure in which a model or set of parameters is updated based on input data, such as time-series data, in order to improve future estimation, determination, or generation performance.

The term “weighting” refers to numerical parameters or factors used to adjust the relative influence of different input signals or features in estimation, determination, or generation processes.

The term “threshold value” refers to a numerical parameter used as a decision boundary in classification, detection, or triggering operations within estimation, determination, or generation processes.

In one embodiment, a server cooperates with a terminal operated by a user to implement the claimed system. The server includes at least one processor, a main memory, a non-volatile storage device, and a network interface. The terminal includes an input device such as a touch panel, a microphone, a camera, motion sensors, and a wireless communication interface. The server and the terminal are connected via a communication network.

The server executes an operating system and a plurality of software modules implementing an information acquisition device, a communication control device, a speech recognition processing device, an image processing device, a feature amount extraction device, a character string formatting device, a language processing device, an information integration device, a discrimination model, a generative information processing model, a notification communication device, a display control device interface, a learning module, and a data management module. The terminal executes an operating system and an application program that communicates with the server and controls local sensors and user interfaces.

The terminal uses hardware sensors, including an accelerometer, a gyroscope, and an optional positioning device, to acquire behavior information such as walking patterns, device orientation, and approximate location. The terminal uses a microphone to acquire audio information corresponding to utterance information of the user, and uses a camera to acquire image information representing facial expressions or body posture. The terminal further acquires character information directly input by the user via a text input field in the application. The terminal transmits these data items to the server through the communication control device in the form of structured messages including timestamps, device identifiers, and modality identifiers.

The server acquires posting information from an external information providing device by using standard communication protocols. For example, the server uses an application programming interface provided by a social networking service to retrieve text posts and associated metadata such as posting time and reaction counts. The server stores all raw data in a storage device in a unified schema that distinguishes between behavior information, utterance information, image information, audio information, character information, and posting information.

The server converts audio information into character information by executing the speech recognition processing device. In one embodiment, the server uses an automatic speech recognition model based on a deep neural network having a convolutional front-end followed by a bidirectional recurrent network and a connectionist temporal classification loss. The server feeds time-frequency representations of the audio signal into the model and obtains character sequences with confidence scores. The server stores the recognized text as character information linked to the original audio segment and its timestamp.

The server processes image information by using the image processing device and the feature amount extraction device. In one embodiment, the server uses an image processing library to perform face detection and cropping, followed by a convolutional neural network model such as a residual network to extract feature amounts. The server obtains intermediate feature vectors from a penultimate layer of the network, representing abstract characteristics of facial expression and posture. The server optionally applies an additional classification layer to map these feature amounts to expression state categories such as “tired,” “stressed,” “neutral,” or “happy,” and to estimate continuous expression intensities. The server records the feature amounts and the derived expression state information as numerical vectors with associated timestamps.

The server applies the character string formatting device and the language processing device to all character information and posting information. The server removes control characters, hyperlinks, markup elements, and non-informative tokens, and normalizes case and character encoding. The server segments multi-byte character strings, performs tokenization into words or subword units, and identifies sentence boundaries. The server optionally performs part-of-speech tagging and lemmatization to reduce morphological variation. The server stores cleaned and tokenized character information in a structured representation that includes token sequences, sentence boundaries, and linguistic annotations.

The server uses the information integration device to generate integrated event information for each user. The server aligns the timestamps of behavior information, utterance information, image information, audio-derived character information, and posting information, and groups them into event windows. Each integrated event includes references to all modalities observed within a defined temporal interval, for example several minutes, and includes aggregated state information such as average motion level, typical device usage, and detected facial expression. This integrated event structure constitutes a specific data structure that enables subsequent multimodal analysis without repeatedly scanning the raw data streams.

The server generates a first prompt sentence for a semantic analysis language model based on the character information included in an integrated event. The server composes the prompt sentence by inserting the actual text data, contextual metadata, and desired output format into a predefined template. In one example, the server generates a prompt sentence such as:

“Analyze the emotional tone and the main concern in the following sentence and respond in English with the emotion and the concern in natural language. Sentence: ‘I've been busy at work lately and I'm tired’.”

In another example, the server generates a prompt sentence such as:
“The user wrote: ‘I've been busy at work lately and I'm tired’. Identify the main concern of the user and briefly explain the reason for your judgment.”

The server inputs the first prompt sentence into the generative information processing model and obtains emotion information and intention information. In one embodiment, the generative information processing model is implemented as a transformer-based neural network with multiple self-attention layers, feed-forward layers, and layer normalization. The server provides the prompt sentence as a sequence of tokens, obtains the model's output token sequence, and parses the output to extract emotion labels, concern categories, and intention descriptors.

The server inputs the feature amounts and the state information into the discrimination model to obtain expression state information and behavior state information. In one embodiment, the discrimination model is implemented as a feed-forward neural network having several fully connected layers with rectified linear activation functions, or as a gradient boosted decision tree model. The server uses training data composed of labeled feature amounts and known expression states to train the discrimination model by minimizing a classification loss such as cross-entropy through backpropagation. The server then uses the trained model at inference time to assign expression state categories and behavior state categories to new feature amounts.

The server integrates the emotion information, the intention information, the expression state information, and the behavior state information by using the information integration device. In one embodiment, the server represents each type of information as a numeric vector in a common embedding space and computes a weighted sum of these vectors. The server applies weights that are adapted based on previously observed performance, and computes a combined state vector representing the overall state of the user for each integrated event. The server then applies a decision function, such as a softmax classifier or a set of rule-based conditions, to the combined state vector to estimate and determine concern information, problem information, and desire information of the user.

The server generates a second prompt sentence based on the concern information, the problem information, and the desire information. The server constructs the second prompt sentence by embedding the identified concerns and contextual constraints into a template designed for advice generation. For example, the server generates a prompt sentence such as: “The user feels tired because work has been very busy. Detected concern: work-related fatigue. Constraints: suggestions must be simple, low-cost, and feasible at home after work; tone must be empathetic; language: Japanese. Task: Provide three concrete, step-by-step actions the user can try tonight and one short motivational message.”

In another example, the server generates a prompt sentence such as:
“The user posted: ‘I've been busy at work lately and I'm tired’. Analyze why the user might feel tired and propose three short, concrete coping strategies. Answer in Japanese and be empathetic.”

The server inputs the second prompt sentence into the generative information processing model. The model produces a natural language response describing solution information such as specific relaxation techniques, schedule adjustments, or self-care actions. The server parses and segments the model's output into components such as a title, a list of suggested actions, and an optional motivational message.

The server transmits the response information, including the solution information, to the terminal via the notification communication device. The terminal receives the response and uses the display control device to present the solution information to the user on a display. The terminal displays the information in a structured layout, for example as a notification, as a list of suggestions, or as an interactive exercise guide. The user may select one of multiple suggested actions or may request additional details. The terminal records the user's selection operation information and transmits it back to the server. The server records presentation results and selection operation information as behavior history information in a time-series structure.

The server sequentially updates the contents and structures of the first prompt sentence and the second prompt sentence based on the behavior history information and the integrated event information. The server analyzes the correlation between previous prompts, model outputs, user interactions, and subsequent user states, and adjusts prompt templates, parameter values, and level of detail. For example, when the server detects that a shorter, more directive prompt sentence yields more stable model outputs and higher user engagement, the server modifies the template accordingly. This adaptive prompt control reduces unnecessary token lengths, lowers communication payload sizes, and improves response time.

The server stores the integrated event information, the emotion information, the intention information, the expression state information, and the behavior state information as time-series data in a structured database. The server executes a learning process using the time-series data to learn state transition information of the user. In one embodiment, the server employs a recurrent neural network, such as a long short-term memory network, that receives sequences of combined state vectors and predicts future states or concern categories. The server trains the recurrent neural network by minimizing a loss function such as mean squared error or cross-entropy between predicted and observed state transitions. The server uses the learned parameters to update weighting factors used in the information integration device and to adjust threshold values used in determining concern information and problem information.

By updating weightings and threshold values, the server gradually refines its internal estimation and determination processes. When the server accumulates more data for a specific user, it adjusts the sensitivity to particular signals, such as late-night device usage or certain linguistic indicators, and thereby improves estimation accuracy. This learning process is not limited to simple rule updates but actively modifies parameters of trained models based on error gradients and observed outcomes, which constitutes an improvement of the computer's internal functioning in handling user state modeling tasks.

The server achieves technical effects beyond mere automation of human judgment. The integration of multimodal data into integrated event information reduces redundant storage operations and avoids repeated scanning of raw logs, resulting in improved data access patterns and lower input/output overhead. The adaptive prompt generation mechanism leads to shorter and more focused prompt sentences, which reduces computational load in the generative information processing model and lowers network traffic between the server and any external model service. The use of time-series state transition learning enables the server to anticipate likely user states and to pre-allocate computation and communication resources efficiently, thereby reducing latency when generating solution information.

In addition, the server applies specific feature extraction and model fusion algorithms that are not conventionally performed by a human. The server continuously computes feature amounts from high-dimensional sensor signals and visual data, applies non-linear transformation and classification layers, and performs vector-based fusion with learned weights. The server uses explicit decision criteria based on numerical thresholds, confidence scores, and loss-based optimization, rather than intuitive or heuristic human reasoning. This non-conventional processing pipeline, including neural architectures, loss functions, and adaptive weighting, improves the precision and robustness of user state inference and advice generation.

In alternative embodiments, the server may employ different neural network architectures in the generative information processing model, such as encoder-decoder architectures with attention, or may distribute the model across multiple processors or devices to parallelize computation. The discrimination model may be replaced by a probabilistic graphical model or a support vector machine while still utilizing the same feature amounts and integrated event structures. The speech recognition processing device and image processing device may be implemented using hardware accelerators such as graphics processing units or dedicated neural processing units to further reduce processing time.

In another embodiment, some pre-processing functions, such as simple tokenization, noise reduction in audio signals, or low-resolution image resizing, may be performed on the terminal to reduce communication bandwidth. In this case, the server still performs the core integration, model inference, prompt generation, and adaptive learning, while the terminal operates as a front-end sensor and display device. This division of labor further improves technical efficiency by reducing server load and network usage.

Through these configurations, the server, the terminal, and the user cooperate in a technical system in which multimodal data are acquired, transformed, integrated, and learned in specific data structures and processing flows. The system improves processing speed by avoiding redundant computations through integrated event information, improves accuracy by learning user-specific state transitions and adjusting model parameters, and reduces error by systematically integrating complementary modalities. The generative AI model is not merely invoked as a black box, but is controlled via adaptively generated prompt sentences that are informed by structured, learned representations of user states. This interaction between prompt control, model inference, and time-series learning yields an improved computer-implemented mechanism for user state inference and personalized solution generation.

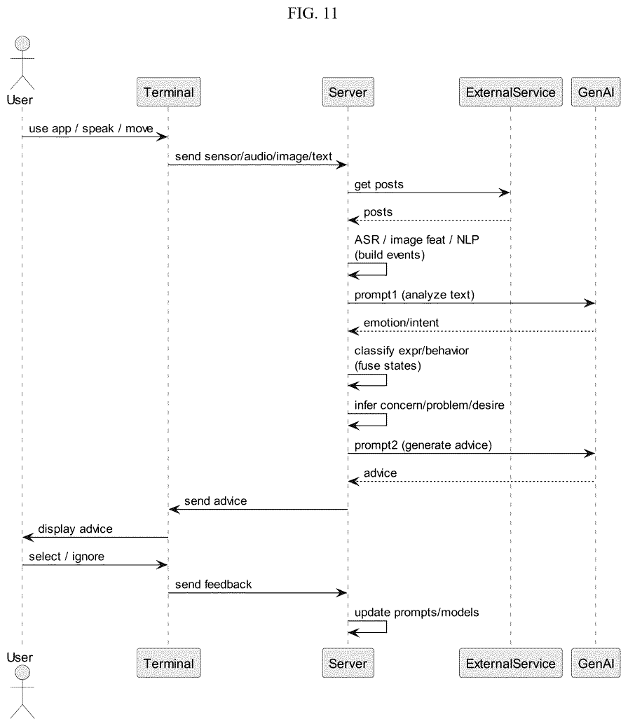

The following describes the processing flow using FIG. 11.

### Step 1:

The user operates the terminal and generates raw data.

The user carries the terminal during daily activities, inputs text in an application, speaks near the microphone, and allows the camera and motion sensors to operate.

Input: user actions such as walking, typing messages, and speaking.

Output: raw sensor readings, audio waveforms, camera images, and locally entered text stored temporarily on the terminal.

### Step 2:

The terminal acquires multimodal data from local hardware.

The terminal reads acceleration and orientation values from motion sensors, samples audio signals from the microphone, captures still images or video frames from the camera, and records user-entered character strings in the application.

Input: electrical signals from sensors, microphone, and camera, and key events from the touch interface.

Output: digitized behavior information, audio information, image information, and character information organized in local data structures with timestamps.

### Step 3:

The terminal transmits collected data to the server.

The terminal groups the multimodal data into transmission units, attaches metadata such as user identifier, device identifier, and timestamps, and sends these units over a network using a secure communication protocol.

Input: locally stored multimodal data and associated metadata.

Output: structured request messages delivered to the server containing the behavior information, audio information, image information, and character information.

### Step 4:

The server acquires additional posting information from an external information providing device.

The server uses the communication control device to send API requests to an external service, specifying the user identifier and a time range, and receives posting information including text posts and associated metadata.

Input: user identifier and query parameters from the server's data management module. Output: posting information records containing post text, timestamps, and other attributes stored in a server-side database.

### Step 5:

The server converts audio information into character information by speech recognition. The server loads the audio information from storage, computes time-frequency features such as spectrogram frames, and inputs these features into the speech recognition processing device, which includes a trained neural network. The network outputs sequences of characters or tokens that the server decodes into text.

Input: audio information segments with timestamps.

Output: recognized character information aligned with the original audio segments and linked to the corresponding user and time.

### Step 6:

The server extracts feature amounts from image information.

The server uses the image processing device to detect a face region or relevant object region in each image frame, crops and resizes the region, and then applies the feature amount extraction device running a convolutional neural network. The network processes the pixel values and produces feature vectors that represent facial expression and posture.

Input: image information frames and associated timestamps.

Output: numerical feature amounts and preliminary expression state labels stored with references to the source images and time indices.

### Step 7:

The server formats and linguistically processes text-based information.

The server applies the character string formatting device to remove control codes, hyperlinks, and extraneous symbols from character information and posting information, and then applies the language processing device to tokenize sentences and words, normalize forms, and optionally assign part-of-speech tags.

Input: raw character information from speech recognition and user input, and raw posting information from the external service.

Output: cleaned and tokenized character sequences with linguistic annotations suitable for semantic analysis.

### Step 8:

The server generates integrated event information per user.

The server aligns behavior information, utterance information, image-derived feature amounts, recognized character information, and posting information along a common timeline. The server groups all data falling within each defined time window into a single record and computes summary attributes such as average activity level and dominant expression state.

Input: timestamped multimodal data from previous steps.

Output: integrated event information objects that encapsulate multimodal user states for each time interval.

The server generates a first prompt sentence for semantic analysis.

The server selects the text elements from an integrated event, such as a user post or transcribed utterance, and inserts them into a predefined textual template that requests emotion and concern analysis.

Input: character information and contextual metadata from an integrated event.

Output: a first prompt sentence such as “Analyze the emotional tone and the main concern in the following sentence and respond in English with the emotion and the concern in natural language. Sentence: ‘I've been busy at work lately and I'm tired’.”

### Step 10:

The server obtains emotion information and intention information using a generative AI model.

The server sends the first prompt sentence as input to the generative information processing model, receives a generated textual response describing emotions and concerns, and parses the response to extract structured emotion labels and intention descriptions.

Input: first prompt sentence containing user text and analysis instructions.

Output: emotion information and intention information associated with the corresponding integrated event.

### Step 11:

The server derives expression state information and behavior state information using a discrimination model.

The server inputs the previously extracted feature amounts and state information, such as motion statistics, into the discrimination model, which evaluates the numerical vectors and outputs categorical labels for expression and behavior states.

Input: visual feature amounts and state information from sensors.

Output: expression state information and behavior state information aligned with each integrated event.

### Step 12:

The server integrates multimodal state information into a unified representation.

The server uses the information integration device to convert emotion information, intention information, expression state information, and behavior state information into numeric vectors, applies learned weights, and computes a combined state vector. The server then applies a decision function to classify this combined state into concern, problem, and desire categories.

Input: emotion, intention, expression state, and behavior state data for an integrated event.

Output: concern information, problem information, and desire information representing the inferred user state.

### Step 13:

The server generates a second prompt sentence for solution generation.

The server takes the concern information, problem information, and desire information, adds contextual constraints such as required language and complexity level, and embeds them in an advice-generation template.

Input: structured concern, problem, and desire information and associated context.

Output: a second prompt sentence such as “The user feels tired because work has been very busy. Detected concern: work-related fatigue. Constraints: suggestions must be simple, low-cost, and feasible at home after work; tone must be empathetic; language: Japanese. Task: Provide three concrete, step-by-step actions the user can try tonight and one short motivational message.”

### Step 14:

The server produces solution information using the generative AI model.

The server sends the second prompt sentence to the generative information processing model, receives a generated natural language answer, and segments the answer into discrete solution units such as action steps and motivational text.

Input: second prompt sentence describing the user's state and required advice format.

Output: response information containing solution information tailored to the user and formatted as a set of suggestions.

### Step 15:

The server transmits response information to the terminal.

The server constructs a notification payload including key parts of the solution information, attaches routing data such as the device identifier, and sends the payload to the terminal through the notification communication device using a push notification service or direct messaging protocol.

Input: response information with solution content and presentation parameters.

Output: network messages delivered to the terminal that carry the solution information.

### Step 16:

The terminal presents solution information to the user.

The terminal receives the notification, invokes the display control device, and renders the solution information on the screen in a readable layout. The terminal may present a short summary in a notification panel and a detailed view containing full step-by-step advice when the user opens the application.

Input: notification payloads and associated solution content from the server.

Output: visual presentation of solution information and interactive elements that the user can operate.

### Step 17:

The user interacts with the presented solution information.

The user reads the suggestions, selects one of several options, starts a proposed exercise, dismisses the notification, or requests alternative advice.

Input: displayed solution information and user interface elements.

Output: user interaction events such as button presses, selection choices, and timestamps captured by the terminal.

### Step 18:

The terminal records user interaction as behavior history information.

The terminal encodes the user's actions, including which suggestion was chosen and whether the exercise was completed, and sends these records to the server along with contextual data such as the time and screen state.

Input: raw interaction events generated by the user's operations on the interface.

Output: structured behavior history information messages transmitted to the server.

### Step 19:

The server stores and manages behavior history information and integrated event information. The server receives the behavior history information, associates it with corresponding integrated events and previously generated solution information, and writes all related records into time-series storage.

Input: behavior history messages from the terminal and integrated event identifiers.

Output: updated time-series datasets linking user states, provided solutions, and observed reactions.

### Step 20:

The server updates prompt control parameters based on accumulated data.

The server analyzes correlations between previous first and second prompt sentences, generative model outputs, user reactions, and subsequent states, and adjusts parameters governing prompt length, level of detail, and emphasis on certain context elements.

Input: time-series records of prompts, model outputs, user state estimates, and user reactions.

Output: revised templates and configuration values for future first prompt sentences and second prompt sentences.

### Step 21:

The server executes a learning process for state transition modeling.

The server feeds sequences of combined state vectors and associated outcomes into a learning algorithm, updates model weights and threshold values to reduce prediction errors, and stores the updated parameters.

Input: time-series integrated event information, emotion information, intention information, expression state information, behavior state information, and behavior history information. Output: refined model parameters and decision thresholds used to improve future estimation of concern, problem, and desire information and to enhance the relevance of generated solution information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems in physical or hybrid retail environments mainly rely on coarse-grained inputs such as historical purchase logs, static user profiles, or simple clickstream data. Such systems typically generate suggestions based on generic correlation patterns and do not continuously reflect fine-grained, real-time behavior or spoken intent of a user at an actual point of decision. As a result, the generated recommendations are often misaligned with the user's immediate concerns, problems, or desires, which degrades user engagement and reduces the effectiveness of automated guidance.

From a computer-technology standpoint, existing architectures treat sensor streams, speech recognition outputs, and recommendation logic as loosely coupled components, often connected through batch-oriented workflows. This separation leads to several technical issues: (i) inefficiency and latency in transforming heterogeneous raw data (time-series sensor data and audio data) into usable feature representations; (ii) limited capability to dynamically update inference models or prompt-generation logic in response to user feedback signals; and (iii) underutilization of advanced language generation components, which are generally invoked in an ad hoc manner without systematic incorporation of structured inference results or closed-loop performance data.

Furthermore, known systems that incorporate generative artificial intelligence models frequently use static, manually crafted prompt sentences. Such prompts are not programmatically adapted to the specific estimation results obtained from machine learning models analyzing user behavior. Consequently, the generative models may produce verbose, unfocused, or irrelevant text which, in turn, causes additional network traffic, screen clutter, and processing overhead on user terminals. The lack of an integrated feedback mechanism to refine both the underlying machine learning models and the prompt sentence templates based on observed user reactions further constrains system performance and scalability. Accordingly, there is a need for an improved computer-implemented system and server-side processing architecture which: (i) efficiently acquires and preprocesses multimodal, time-series data from detection apparatuses and audio acquisition apparatuses; (ii) applies machine learning models to estimate user concerns, problems, and desires from such feature data in real time; (iii) automatically constructs and optimizes prompt sentences supplied to a generative artificial intelligence model based on structured estimation results and recommendation targets; and (iv) closes the loop by logging and analyzing user selections, operations, and viewing behavior so as to update the machine learning models and prompt templates. By addressing these technical issues, the system can improve the quality, precision, and responsiveness of recommendations and explanatory content, thereby achieving a concrete improvement in the functioning of the computer system itself.

The specific processing by the specific processing unit 290 of the data processing device 12 in Application Example 1 is realized by the following means.

The present invention provides a server comprising a processor and a memory storing instructions that, when executed by the processor, cause the processor to acquire, via a detection apparatus and an audio acquisition apparatus, time-series data including user behavior information and user audio information, perform digital signal processing and statistical processing on the time-series data to generate feature data, input character string data obtained from the user audio information and the feature data to a machine learning model to calculate an estimation result indicating at least one concern, problem, or desire of the user, refer to an information storage apparatus storing the estimation result and item information or service information in association with each other to extract candidate information corresponding to the estimation result and determine recommendation target information, generate a prompt sentence based on the estimation result and the recommendation target information and input the prompt sentence to a generative artificial intelligence model so as to cause the generative artificial intelligence model to generate explanation text information or proposal text information to be presented to the user, generate notification information including the explanation text information or the proposal text information and the recommendation target information and transmit the notification information to a user terminal via a communication apparatus, acquire selection information or operation information of the user with respect to the notification information received by the user terminal and record the selection information or the operation information in association with the estimation result and the recommendation target information, and update at least one of (i) the machine learning model and (ii) a generation method of the prompt sentence based on the record. This enables a computer system to more efficiently transform heterogeneous sensor and audio data into semantically rich, context-specific recommendations and explanatory messages, to reduce latency and processing overhead associated with irrelevant or non-personalized content generation, and to continuously optimize both predictive models and generative prompt logic in response to observed user behavior, thereby improving the technical performance and accuracy of automated recommendation and guidance functions.

The term “system” refers to an arrangement including at least one server, at least one user terminal, and one or more apparatuses and storage units that cooperate to perform acquisition, processing, inference, recommendation, generation, transmission, and logging of information as described in the claims.

The term “processor” refers to a hardware processing unit, such as a central processing unit or other computation circuitry, configured to execute instructions to perform the functions described in the claims.

The term “memory” refers to a hardware storage medium, such as a volatile memory device or a non-volatile memory device, configured to store instructions and data for access by the processor.

The term “detection apparatus” refers to hardware configured to detect physical phenomena relating to a user, such as position, movement, presence, or interaction, and to output corresponding detection signals.

The term “audio acquisition apparatus” refers to hardware configured to capture sound, including user speech, and to output corresponding audio signals.

The term “time-series data” refers to data values representing measurements or observations that are ordered in time and include, as elements, detection signals from the detection apparatus and audio signals from the audio acquisition apparatus.

The term “digital signal processing” refers to computational operations applied to digitized signals, including filtering, noise reduction, transformation, normalization, or segmentation, to obtain processed signal data.

The term “statistical processing” refers to computational operations based on statistical methods, including aggregation, smoothing, outlier removal, or normalization, to derive structured data from raw or preprocessed data.

The term “feature data” refers to numerical or categorical representations derived from the time-series data through digital signal processing and statistical processing and suitable for input to a machine learning model.

The term “character string data” refers to text data obtained, for example, by converting captured audio into text using speech recognition, the text data representing words or phrases expressed by a user.

The term “machine learning model” refers to a computational model trained on data to automatically learn patterns and to output an estimation result when provided with feature data and character string data.

The term “estimation result” refers to output data generated by the machine learning model that characterizes one or more inferred states of a user, including at least one concern, problem, or desire.

The term “concern” refers to an inferred matter of interest or anxiety of a user, as determined by analyzing behavior information, audio information, or both.

The term “problem” refers to an inferred difficulty, inconvenience, or deficiency experienced by a user, as determined by analyzing behavior information, audio information, or both.

The term “desire” refers to an inferred wish, preference, or intention of a user to obtain a particular item, service, or outcome.

The term “information storage apparatus” refers to hardware and associated software configured to store data, including associations between estimation results and item information or service information, in a retrievable form.

The term “item information” refers to data that describes a physical or digital good, including identifiers, attributes, conditions, and pricing information.

The term “service information” refers to data that describes a provided service, including identifiers, attributes, conditions, and pricing information.

The term “candidate information” refers to a subset of item information or service information that is selected based on correspondence with an estimation result.

The term “recommendation target information” refers to information representing one or more items or services that are selected from the candidate information as recommended to the user.

The term “prompt sentence” refers to a text sequence that is supplied as input to a generative artificial intelligence model to control or condition generation of explanation text information or proposal text information.

The term “generative artificial intelligence model” refers to a trained computational model configured to generate text data in response to an input including at least a prompt sentence. The term “explanation text information” refers to text generated by the generative artificial intelligence model that explains attributes, benefits, or usage of one or more items or services to the user.

The term “proposal text information” refers to text generated by the generative artificial intelligence model that proposes one or more items or services to the user as possible solutions to an inferred concern, problem, or desire.

The term “notification information” refers to data including at least one of explanation text information and proposal text information and including recommendation target information, the data being formatted for delivery to a user terminal.

The term “communication apparatus” refers to hardware and associated software configured to transmit information between the server and the user terminal over a communication network.

The term “user terminal” refers to an electronic device operated by a user, such as a mobile device, a computing device, or a display device, configured to receive and present notification information and support explanation text information.

The term “selection information” refers to data indicating a choice or preference of a user, such as a selection of an item, a service, or an action, made in response to notification information.

The term “operation information” refers to data indicating one or more operations performed by a user with respect to notification information or displayed content, including clicks, taps, scrolls, or other user interface interactions.

The term “record” refers to stored data that associates selection information or operation information with a corresponding estimation result and recommendation target information. The term “generation method of the prompt sentence” refers to logic, rules, templates, or computational procedures that determine how a prompt sentence is constructed from underlying data including estimation results and recommendation target information.

The term “execution processing” refers to control operations performed to implement a recommended solution, such as initiating fulfillment, configuration, or activation related to recommendation target information.

The term “reservation processing” refers to control operations for reserving an item or a service associated with recommendation target information.

The term “purchase processing” refers to control operations for ordering, billing, or completing a transaction for an item or a service associated with recommendation target information.

The term “support information” refers to data generated for the purpose of assisting a user in executing, using, or following up on a recommended solution, the data being used as or within a prompt sentence.

The term “support explanation text information” refers to text generated by the generative artificial intelligence model based on support information, the text including at least one of an execution procedure, a usage method, or follow-up information.

The term “transmission history” refers to logged data indicating occurrences of sending notification information or support explanation text information to a user terminal.

The term “viewing status” refers to data representing whether and how a user has displayed, read, or otherwise engaged with support explanation text information on a user terminal.

The term “evaluation information” refers to data generated by analyzing transmission history, selection information, operation information, and viewing status to represent a behavior tendency, a preference, or a response tendency of a user.

The term “behavior tendency” refers to a pattern inferred from user actions over time, including typical responses to notifications, frequency of selections, or interaction styles.

The term “preference” refers to an inferred inclination of a user toward certain types of items, services, presentation styles, or contents based on observed behavior.

The term “response tendency” refers to an inferred pattern of how a user reacts to notifications and generated text, including likelihoods of opening, ignoring, or acting upon information.

The term “training data of the machine learning model” refers to data used to train or retrain the machine learning model, including feature data, character string data, and labeled or derived outputs.

The term “template of the prompt sentence” refers to a predefined or adaptable text structure including placeholders or rules, used to systematically generate prompt sentences supplied to the generative artificial intelligence model.

The server provides an implementation form of the invention by executing computer programs stored in a memory and running on a processor in cooperation with a detection apparatus, an audio acquisition apparatus, an information storage apparatus, a communication apparatus, and a user terminal. The server is physically realized, for example, on a general-purpose computing platform that includes at least one central processing unit, a main memory, a non-volatile storage device, and network interfaces. The detection apparatus and the audio acquisition apparatus are realized, for example, by sensor modules and microphone modules connected to an edge-computing board such as a single-board microcomputer or a microcontroller board. The user terminal is realized, for example, by a handheld computing device, a tablet device, or a personal computer on which an application program or a web browser runs.

The server uses the detection apparatus and the audio acquisition apparatus to continuously obtain time-series data representing user behavior information and user audio information in a physical environment such as a store. The server receives, as behavior-related data, sensor outputs from position sensors, proximity sensors, motion sensors, optical sensors, or radio beacons, and the server converts analog signals from such sensors into digital values via an analog-to-digital converter on the edge-computing board. The server also receives audio signals captured by the audio acquisition apparatus, and the server digitizes and buffers the audio signals as pulse-code-modulated streams. The server associates each sample of time-series data with timestamps, device identifiers, and location identifiers, and the server stores the data into structured data records in a database management system.

The server applies digital signal processing operations to the time-series data using software libraries such as numerical computation libraries and signal-processing libraries. The server performs operations such as high-pass filtering, low-pass filtering, and band-pass filtering to remove noise components from the sensor signals and audio signals. The server applies resampling and windowing operations to normalize sampling rates and to partition the time-series data into fixed-length segments. The server performs statistical processing such as mean normalization, standardization, outlier removal based on z-scores, and interpolation of missing values. As a result, the server generates feature data that compress raw signals into lower-dimensional numeric vectors that still preserve discriminative information about user behavior and speech.

The server converts the audio information into character string data by executing an automatic speech recognition (ASR) component. The server uses, for example, a deep neural network based acoustic model combined with a language model implemented on a computing platform or a cloud-based speech recognition service. The server segments incoming audio into utterance units using voice activity detection, and the server feeds each segment into the ASR component to obtain a text transcription. The server stores the character string data, along with confidence scores and timestamps, into a text data store.

The server constructs feature data by combining behavior-related features and speech-related features. The server, for behavior-related features, calculates dwell time in front of particular zones, velocity and acceleration patterns of user movement, frequency of approach to specific areas, and repetition of similar motion patterns. The server, for speech-related features, performs tokenization, part-of-speech tagging, and keyword extraction on the character string data using a natural language processing (NLP) library. The server encodes the tokens using, for example, word embeddings or subword embeddings and aggregates them into fixed-length vectors. The server concatenates the behavior-related feature vectors and the speech-related feature vectors to obtain unified feature vectors for each user session.

The server employs a machine learning model that receives the unified feature vectors and character string data as inputs and outputs an estimation result describing one or more concerns, problems, or desires of the user. In one embodiment, the server implements a neural network model that includes: (i) a text encoder based on a transformer architecture having multi-head self-attention layers and feedforward layers; (ii) a behavior encoder based on a recurrent neural network such as a gated recurrent unit or a long short-term memory unit for time-series sensor data; and (iii) a fusion layer that concatenates or attends over the outputs of the two encoders. The server trains this model using supervised learning, where training labels represent categories of user concerns, problems, or desires and are associated with historical sessions. The server minimizes a loss function such as cross-entropy loss or focal loss by performing gradient-based optimization, for example stochastic gradient descent or an adaptive optimizer. The server updates model weights by backpropagating the error gradients through the network layers.

The server improves technical performance by adopting this multimodal architecture because the fusion of sensor-derived features and speech-derived features reduces the estimation error compared to using either modality alone. The server thus increases the accuracy of identifying fine-grained user intent, which reduces unnecessary communication and processing associated with irrelevant recommendations. The server also reduces latency by computing feature vectors in an online fashion and by employing vectorized operations and batched inference on the machine learning model.

The server stores the trained machine learning model parameters in the memory and loads the parameters into the processor during inference. The server then applies the model to run forward propagation on real-time feature vectors, thereby generating an estimation result that includes, for each candidate concern, problem, or desire, a confidence value. The server stores the estimation result in association with a user session identifier and other context information in the information storage apparatus.

The server refers to the information storage apparatus that stores associations between estimation results and item information or service information. The server executes database queries to retrieve candidate information whose metadata matches the inferred categories, numeric thresholds, or attribute constraints indicated by the estimation result. The server, for example, retrieves all items within a certain category that satisfy attribute conditions such as resolution level, capacity value, or power performance. The server then applies a ranking algorithm that may include gradient-boosted decision trees or a learning-to-rank neural model to sort candidate items based on relevance scores that incorporate the estimation result, item popularity, inventory status, and historical user response patterns.

The server determines recommendation target information by selecting top-ranked items or services that satisfy predetermined constraints on number, diversity, or coverage of user needs. The server converts the selected items or services into recommendation target records that include item identifiers, service identifiers, short descriptions, prices, discounts, and images. The server stores these recommendation target records in memory and uses them as input material for text generation.

The server generates a prompt sentence to be supplied to a generative AI model. The server constructs the prompt sentence using a template that includes placeholder fields for user context, estimated concerns, problems, or desires, and attributes of recommendation target information. The server fills the placeholders with text tokens derived from the estimation result and item or service descriptions. The server, for example, generates a prompt sentence such as:
“The customer is standing in front of the smartphone section and said: ‘I want a new smartphone with a good camera and long battery life.’ The system has selected three smartphones that match these needs. Write a short, persuasive explanation for each smartphone, in less than 50 words, suitable for a mobile app notification.”

The server, in another example, generates a prompt sentence such as:
“Given that the user is interested in devices with long battery life and often uses the camera in low light, generate a concise explanation for why each of the following products is suitable, and emphasize technical features such as battery capacity and camera sensor performance.”

The server inputs the prompt sentence into a generative AI model. The server, for one embodiment, uses a transformer-based language model stored and executed on the server itself or on a connected computational resource. The generative AI model is configured with multiple self-attention layers, feedforward layers, and layer normalization, trained on large-scale text data. The server conditions the generative AI model on the specific prompt sentence and optionally on structured tags such as item category or style constraints. The server runs the model in inference mode using beam search or nucleus sampling with predefined parameters for temperature, top-k, and top-p to generate explanation text information or proposal text information.

The server improves technical efficiency by using prompt templates and by incorporating structured estimation results directly into the prompt sentence. This design leads to concentrated, contextually relevant text output, which reduces text length variability and lowers network bandwidth usage when transmitting notification information to the user terminal. The server further reduces device-side processing overhead because the user terminal only needs to render focused, short explanations instead of parsing or trimming long, generic texts.

The server constructs notification information by combining the explanation text information or proposal text information with the recommendation target information. The server packages these contents into a structured message format and transmits the notification information to the user terminal via the communication apparatus using a network protocol. The communication apparatus implements, for example, wireless communication over a local network or a wide-area network, and provides secure transport by using encryption and authentication mechanisms.

The terminal receives the notification information and stores it in a local buffer or application storage. The terminal displays the notification information using a graphical user interface. The terminal, for example, presents a card-style view that includes the generated explanation text, item images, price information, and interactive elements such as selection buttons. The terminal facilitates user input via touch, mouse, or keyboard operations. The terminal transmits user selections or operations back to the server as selection information or operation information.

The user reads the explanation text or proposal text on the terminal and optionally compares multiple recommendations. The user selects an item or a service by interacting with user interface components, such as tapping an “Add to cart” button or a “More details” button. The user may also dismiss or ignore certain recommendations. The user's actions are converted into selection information or operation information and sent from the terminal to the server.

The server receives the selection information or operation information and records it in association with the estimation result and the recommendation target information. The server uses a logging module to store event logs including identifiers of the notification information, user selections, timestamps, and device context. The server uses these logs to generate a record describing how specific estimation results and recommendation target information influenced user behavior.

The server manages execution processing, reservation processing, or purchase processing related to the selected recommendation target information by interacting with backend systems such as inventory management systems or ordering systems. The server determines outcomes of such processing and then prepares support information that describes recommended usage procedures, configuration steps, or follow-up actions. The server converts the support information into another prompt sentence and inputs it into the generative AI model. The server, for example, generates a prompt sentence such as:
“Generate a step-by-step setup guide for a customer who just bought a smartphone model X and is not familiar with data transfer from an old phone. Use clear short steps and focus on data backup, transfer, and verification.”

The server obtains support explanation text information from the generative AI model. The server then transmits this support explanation text information to the terminal as part of a support message. The terminal displays the support explanation text information as a guided interface or checklist. The user follows the guidance to complete configuration or usage of the purchased item or service.

The server analyzes transmission history of notification information, user selection information, user operation information, and viewing status of support explanation text information. The server aggregates these data into evaluation information representing user behavior tendencies, preferences, and response tendencies. The server employs statistical analysis and additional machine learning algorithms such as clustering or reinforcement learning to study how changes in estimation models or prompt templates influence user actions. The server then updates the training data of the machine learning model by appending newly labeled data derived from user responses, and the server retrains or fine-tunes the model to improve estimation accuracy.

The server also updates the template of the prompt sentence by adjusting phrases, structure, and level of detail based on performance metrics such as click-through rates, conversion rates, and reading duration. The server thereby implements a closed-loop optimization that continuously refines both the predictive model and the prompt-generation method. This closed-loop design enhances the technical performance of the overall system by reducing prediction errors, concentrating generative text contents, and lowering computational and communication overhead required for ineffective recommendations.

The server, by using the above-described architecture, does not merely automate a human recommendation process. The server implements specific data structures for multimodal feature vectors, concrete neural network architectures for fused inference, and systematic prompt-generation templates that leverage structured inference outputs. The combination of these features results in measurable improvements in technical metrics such as estimation accuracy, inference latency, bandwidth usage, and storage efficiency. Because the server transforms raw sensor and audio streams into optimized recommendation and guidance messages through specific computational pipelines and feedback-controlled model updates, the invention constitutes an improvement in computer technology, including improved data handling, improved model utilization, and improved overall system efficiency.

The server may employ alternative embodiments without departing from the scope of the claims. For example, the server may replace the recurrent neural network in the behavior encoder with a temporal convolutional network or attention-based encoder to further reduce inference time. The server may alter the generative AI model from a large-scale transformer to a smaller distilled model running on local hardware in environments with network constraints. The server may implement different loss functions such as margin-based ranking loss or multi-task losses that jointly optimize classification of concerns and regression of satisfaction scores. The server may adopt different optimization methods such as batch normalization, dropout, or weight regularization to improve generalization.

The terminal may be realized as a head-mounted display, a public kiosk, or an in-vehicle device, depending on use cases. The detection apparatus may be realized using cameras combined with computer vision algorithms for tracking, or using wearable sensors that detect biometric signals. The audio acquisition apparatus may be realized as a microphone array that enables direction-of-arrival estimation, thereby refining user localization. These variations demonstrate that the described implementation forms support a wide range of hardware configurations while preserving the core technical features of multimodal inference, structured prompt generation for a generative AI model, and closed-loop optimization based on user responses.

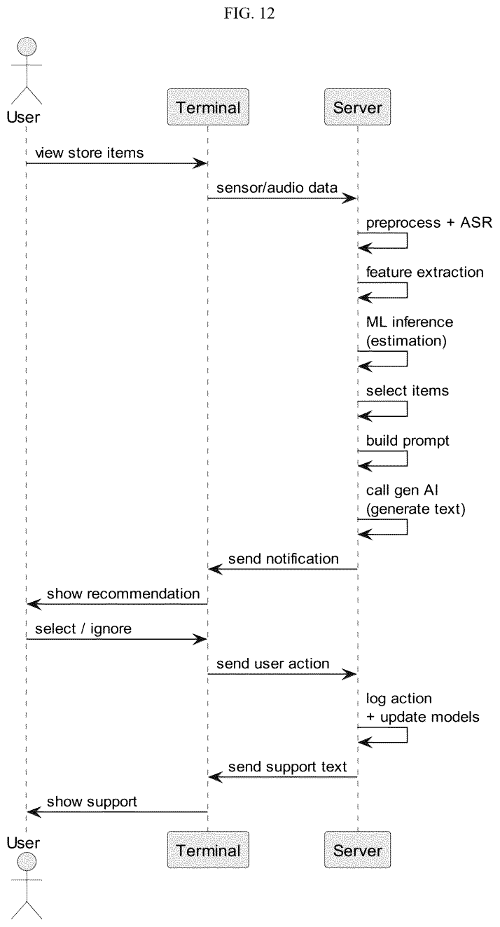

The following describes the processing flow using FIG. 12.

### Step 1:

The server acquires raw behavior data and audio data from the detection apparatus and the audio acquisition apparatus.

The input is analog or low-level digital signals from sensors (for example, position sensors, motion sensors, optical sensors, and radio beacons) and from microphones.

The server converts the analog signals into digital samples using an analog-to-digital converter, tags each sample with a timestamp, a device identifier, and a location identifier, and stores the samples as time-series records in a data store.

The output is a set of synchronized time-series data streams representing user position, movement, and audio in a digital format.

### Step 2:

The server performs digital signal processing and statistical processing on the time-series data to generate normalized sensor streams and audio segments.

The input is the raw time-series data produced in Step 1.

The server applies filters (for example, low-pass filters and high-pass filters) to remove noise, resamples the data to a uniform sampling rate, and segments the time-series into fixed-length windows.

The server computes statistical values such as mean, variance, and maximum for each window and discards outlier samples based on statistical thresholds.

The output is a collection of cleaned and segmented sensor windows and audio windows with consistent sampling and reduced noise.

### Step 3:

The server converts the audio windows into character string data using an automatic speech recognition process.

The input is the cleaned and segmented audio windows from Step 2.

The server performs voice activity detection to detect speech regions, extracts acoustic features such as mel-frequency cepstral coefficients, and inputs these features into a trained acoustic-linguistic model.

The server decodes the model outputs using a language model and generates text transcriptions of spoken utterances, along with confidence scores.

The output is character string data representing the recognized user speech, aligned with timestamps, together with recognition confidence values.

### Step 4:

The server computes feature data from the sensor windows and the character string data. The input is the cleaned sensor windows from Step 2 and the recognized text from Step 3. The server, for behavior information, calculates dwell time near specific zones, movement speed, acceleration, and repetition patterns by aggregating sensor values over each time window.

The server, for speech information, performs tokenization, part-of-speech tagging, and keyword extraction on the text, and converts tokens into numerical embeddings using a trained embedding table.

The server concatenates the behavior features and the speech embeddings into unified feature vectors for each user session or time window.

The output is feature data consisting of unified feature vectors that represent combined behavior and speech characteristics for the user.

### Step 5:

The server estimates user concerns, problems, and desires by applying a machine learning model to the feature data and character string data.

The input is the unified feature vectors and the character string data from Step 4.

The server feeds the text into a text encoder and the behavior features into a behavior encoder within a trained neural network, and then applies a fusion layer that combines the encoded representations.

The server computes output scores for multiple categories (for example, “seeking long battery life,” “seeking discount,” “interested in camera performance”) using a final classification layer and a softmax or sigmoid function.

The server selects categories whose scores exceed predetermined thresholds and aggregates them into an estimation result describing user concerns, problems, and desires.

The output is an estimation result that includes inferred categories and corresponding confidence scores.

### Step 6:

The server selects item information and service information that correspond to the estimation result.

The input is the estimation result from Step 5 and a product or service database stored in the information storage apparatus.

The server formulates database queries that filter items and services based on attributes that match the inferred categories, such as performance parameters, price ranges, or usage types. The server retrieves candidate information records from the database and computes relevance scores for each candidate by applying a ranking algorithm that uses the estimation result, historical response data, and inventory conditions.

The server sorts the candidates according to the relevance scores and selects a subset as recommendation target information.

The output is recommendation target information including identifiers, attributes, prices, and metadata for one or more items or services.

### Step 7:

The server generates a prompt sentence for a generative AI model using the estimation result and the recommendation target information.

The input is the estimation result from Step 5 and the recommendation target information from Step 6.

The server applies a prompt template that defines sentence structure and placeholders for user context, inferred needs, and product or service attributes.

The server fills the placeholders by inserting text phrases that describe the user's inferred concerns or desires and key features of the recommended items or services, and concatenates them into a coherent text query.

The output is a prompt sentence that encodes the context and recommendation goals for the generative AI model.

### Step 8:

The server generates explanation text information or proposal text information by providing the prompt sentence to a generative AI model.

The input is the prompt sentence produced in Step 7.

The server sends the prompt sentence to a transformer-based language model, runs the model in inference mode, and receives a sequence of generated tokens.

The server optionally applies post-processing such as truncation to a maximum length, removal of unwanted tokens, and insertion of item names or numeric values into designated slots in the generated text.

The output is explanation text information or proposal text information that describes why the recommended items or services address the user's concerns, problems, or desires.

The server constructs notification information that combines text and recommendation data and transmits it to the terminal.

The input is the explanation text information or proposal text information from Step 8 and the recommendation target information from Step 6.

The server creates a structured notification object that includes a title, the generated text, references to images, prices, and deep links for each recommended item or service.

The server serializes this object into a message format and sends it through the communication apparatus using a network protocol such as a push-notification or messaging protocol.

The output is notification information delivered to the terminal, ready for presentation to the user.

### Step 10:

The terminal receives and displays the notification information to the user.

The input is the notification information transmitted by the server in Step 9.

The terminal parses the notification payload, stores necessary fields in application memory, and renders a user interface element that shows the text explanation, item images, and interactive controls such as selection buttons.

The terminal updates the display to present the notification in real time, and waits for user interaction events such as taps, clicks, or scrolls.

The output is a visual and interactive presentation of the recommendation and explanation on the terminal screen.

### Step 11:

The user reviews the displayed notification and performs an interaction indicating interest or disinterest.

The input is the visual and textual content shown on the terminal in Step 10.

The user reads the explanation text, compares the recommended items, and decides whether to select an item, request more details, or dismiss the notification.

The user performs operations such as tapping a “Select,” “Details,” or “Close” button, which the terminal converts into structured interaction events.

The output is user interaction information that reflects the user's selection or operation.

### Step 12:

The terminal transmits selection information or operation information to the server.

The input is the interaction events triggered by the user in Step 11.

The terminal encodes the events into a data structure that includes identifiers of the notification, the selected item or service, the specific button pressed, and a timestamp.

The terminal sends this data structure to the server over a secure communication channel and optionally confirms delivery.

The output is a message received by the server that contains selection information or operation information associated with the notification.

### Step 13:

The server records the selection information or operation information in association with the estimation result and the recommendation target information.

The input is the selection information or operation information from Step 12, together with the previously stored estimation result from Step 5 and recommendation target information from Step 6.

The server constructs a log entry that links these three types of data via session identifiers and timestamps, and writes the log entry into a logging database or event store.

The server may compute additional derived fields, such as whether the user accepted or rejected each recommendation, and attach these indicators to the log entry.

The output is a persistent record that ties user behavior to specific inference outputs and recommendations.

### Step 14:

The server manages execution processing, reservation processing, or purchase processing for selected items or services and generates support information.

The input is the selection information from Step 12 and the recommendation target information from Step 6.

The server, when a purchase or reservation is requested, communicates with backend systems to update inventory, create orders, or schedule services, and checks the outcome of these transactions.

The server creates support information that describes the actions completed and lists subsequent steps the user may need to perform, such as configuration or usage operations. The output is structured support information that can be used as context for further guidance to the user.

### Step 15:

The server generates a new prompt sentence from the support information and obtains support explanation text information from the generative AI model.

The input is the support information produced in Step 14.

The server formats the support information into a prompt that requests instructional or follow-up content, using a template with placeholders for the purchased item or service, user skill level, and target task.

The server sends this prompt to the generative AI model, receives generated text describing procedures, usage tips, or follow-up steps, and optionally refines the text by limiting length or clarifying terminology.

The output is support explanation text information tailored to the user's selected item or service and intended task.

### Step 16:

The server transmits the support explanation text information to the terminal and the terminal presents it to the user.

The input is the support explanation text information from Step 15.

The server packages the text into a support message and sends it via the communication apparatus to the terminal.

The terminal receives the message, parses the content, and displays the support explanation text in a guided interface such as a step-by-step view, checklist, or help page.

The output is an on-screen guide that assists the user in executing or using the selected item or service.

### Step 17:

The server analyzes logs of notifications, user interactions, and viewing status to update models and prompt templates.

The input is the records created in Step 13 and any logs of viewing status for support explanation text information, such as open times and dwell durations.

The server aggregates these logs, computes metrics such as click-through rates, conversion rates, and completion rates, and derives evaluation information that characterizes user behavior tendencies and preferences.

The server uses the evaluation information to modify training datasets for the machine learning model and to adjust parameters or structures of prompt templates for the generative AI model, and optionally triggers retraining or fine-tuning processes.

The output is an updated machine learning model and updated prompt-generation logic that improve estimation accuracy, recommendation quality, and communication efficiency in subsequent processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recommendation systems that assist users in solving personal concerns or issues typically rely on fixed rules, manually curated content, or simple keyword matching. Such systems often process user input as short queries, map the queries to predefined categories, and return static advice stored in a database. These approaches suffer from several technical limitations. First, they do not effectively leverage the full semantic content of natural language input, so subtle contextual information in long free-form user descriptions is lost. Second, they generally perform either database retrieval or content generation in isolation and are not configured to integrate retrieved structured information with advanced natural language generation in a coordinated processing flow. As a result, the output is frequently generic, repetitive, or poorly tailored to the user's specific situation.

From a computer technology standpoint, there is a further problem that existing architectures do not provide a standardized mechanism for automatically constructing and managing distinct prompt sentences for different processing stages, such as analysis of user input and generation of personalized solutions, when interacting with a generative artificial intelligence model. In many cases, prompt construction is ad hoc and embedded directly in application logic, which makes it difficult to reuse, optimize, or adapt prompts based on ongoing user interaction. This leads to inefficient use of computational resources on the server side, suboptimal utilization of the generative artificial intelligence model, and limited scalability when the system must handle a large number of users and diverse categories of concerns.

In addition, conventional systems lack an iterative refinement mechanism that feeds additional user input back into an integrated pipeline including natural language processing, information retrieval from a storage device, and generative model invocation. When users provide follow-up questions or clarifications, existing systems often treat such inputs as independent requests or simply append them to previous text without structured re-analysis. This results in fragmented context handling, redundant computation, and a failure to improve solution quality over time in a systematic manner. Thus, there is a need for a computer-implemented technique that configures a processor, a communication device, and a storage device in such a way that the system can (i) accurately analyze user-provided natural language input, (ii) retrieve and incorporate relevant categorized information from a storage device, (iii) automatically construct stage-specific prompt sentences for a generative artificial intelligence model, and (iv) iteratively refine generated solution candidates as additional input is received, thereby improving both the technical efficiency and effectiveness of the overall recommendation process.

The specific processing by the specific processing unit 290 of the data processing device 12 in Example 2 is realized by the following means.

The present invention provides a server comprising a processor, a communication device, and a storage device, the processor being configured to receive, via the communication device, input information described in natural language from a user through a terminal device, to analyze the input information by using a natural language processing technique and to identify a category of a concern or issue included in the input information and summary information corresponding to the concern or issue, to issue, based on the identified category and the input information, a search request to the storage device and to acquire, from the storage device, related information classified into at least one field including a health field, an exercise field, and a diet field, to generate a prompt sentence including the input information and the acquired related information and to input the prompt sentence to a generative artificial intelligence model so as to cause the generative artificial intelligence model to generate a solution candidate for the user, to generate, as a separate operation, a first prompt sentence for analysis of the input information and a second prompt sentence for generation of the solution candidate based on the related information, the first prompt sentence and the second prompt sentence being different from each other, and to cause the generative artificial intelligence model to perform respective generation processes based on the first prompt sentence and the second prompt sentence, and to, when additional input information is received from the user through the terminal device via the communication device, input the additional input information again into a processing flow using the natural language processing technique and the storage device, update the prompt sentence for the generative artificial intelligence model based on the additional input information, and iteratively improve the solution candidate generated by the generative artificial intelligence model. This enables a computer-implemented system to more efficiently and accurately transform free-form natural language input into context-aware, personalized solution candidates by technically structuring the interaction between natural language analysis, categorized information retrieval, and staged prompt control for a generative artificial intelligence model, and by providing an iterative refinement mechanism that improves recommendation quality and resource utilization as user interaction continues.

The term “system” refers to a combination of one or more hardware components and one or more software components that cooperate to perform the functions described herein. The term “server” refers to an electronic device or a group of electronic devices configured to provide computational functions and communication functions over a network to one or more client devices.

The term “processor” refers to one or more hardware circuits, such as a central processing unit, a graphics processing unit, a digital signal processor, or a combination thereof, configured to execute instructions and perform arithmetic, logical, control, and input/output operations.

The term “communication device” refers to one or more hardware and software components, such as network interfaces, wireless transceivers, or communication controllers, configured to send and receive data between the server, a terminal device, and external systems over a wired or wireless network.

The term “storage device” refers to one or more computer-readable media, such as semiconductor memory, magnetic storage, or optical storage, and associated control circuitry, configured to store data, programs, models, and information used by the processor.

The term “terminal device” refers to an electronic device operated by a user, such as a mobile device, a portable computing device, or a stationary computing device, configured to exchange data with the server via the communication device and to present information to the user.

The term “user” refers to a human individual or an organization that interacts with the system through a terminal device in order to provide input information and to receive solution candidates.

The term “input information” refers to data provided by the user to the system through the terminal device, including at least text described in natural language that expresses the user's concerns, issues, or desired goals.

The term “natural language” refers to a human language, such as a spoken or written language used for everyday communication, as opposed to a formal programming language or a markup language.

The term “natural language processing technique” refers to a set of algorithms or software processes configured to analyze text or speech in a natural language, including operations such as tokenization, parsing, semantic analysis, categorization, or intent recognition.

The term “concern or issue” refers to a problem, difficulty, objective, or situation that the user desires to understand, manage, or improve, and that is described in the input information. The term “category” refers to a classification label or type that indicates a field or domain to which the concern or issue belongs, such as a health-related category, an exercise-related category, or a diet-related category.

The term “summary information” refers to data representing a condensed description of the concern or issue identified from the input information by the natural language processing technique.

The term “search request” refers to a command or query generated by the processor and directed to the storage device, specifying retrieval conditions for acquiring related information associated with the identified category or the input information.

The term “related information” refers to data stored in the storage device that is associated with a particular category or concern or issue, and that may include guidance, recommendations, examples, or reference data classified into one or more fields such as a health field, an exercise field, or a diet field.

The term “health field” refers to a domain of information relating to physical or mental well-being, medical considerations, lifestyle habits, or preventive care.

The term “exercise field” refers to a domain of information relating to physical activities, movement programs, training plans, or fitness routines intended to improve or maintain bodily function.

The term “diet field” refers to a domain of information relating to food intake, nutritional balance, meal planning, or eating habits.

The term “prompt sentence” refers to a text sequence generated by the processor and provided as input to a generative artificial intelligence model, the text sequence including instructions, context, and one or more pieces of information such as the input information or the related information, and being configured to cause the generative artificial intelligence model to perform a specified generation process.

The term “generative artificial intelligence model” refers to a machine learning model or a set of machine learning models configured to generate output data, such as text, based on input data including a prompt sentence, by using learned parameters obtained from training on example data.

The term “solution candidate” refers to text or structured data generated by the generative artificial intelligence model that proposes one or more actions, recommendations, or plans intended to address the user's concern or issue.

The term “first prompt sentence” refers to a prompt sentence specifically constructed to cause the generative artificial intelligence model to analyze the input information and to output analysis-related data, such as categories, summaries, or keywords.

The term “second prompt sentence” refers to a prompt sentence specifically constructed to cause the generative artificial intelligence model to generate a solution candidate based at least on the related information acquired from the storage device and optionally on the analysis-related data.

The term “additional input information” refers to input information subsequently provided by the user after an initial interaction, including follow-up questions, clarifications, updates, or new concerns related to a previous concern or issue.

The term “processing flow” refers to an ordered set of computational operations executed by the processor, including natural language analysis of input information, retrieval of related information from the storage device, construction of prompt sentences, and invocation of the generative artificial intelligence model.

The term “iteratively improve” refers to a process in which the processor repeatedly updates a solution candidate by receiving additional input information, re-executing at least part of the processing flow, and invoking the generative artificial intelligence model with updated prompt sentences so that subsequent solution candidates reflect prior context and new information.

In one embodiment, a server cooperates with a terminal and a user to implement the claimed system. The server includes a processor, a communication device, and a storage device. The terminal includes at least one processor, a memory, a communication interface, and a display unit. The user operates the terminal to input natural language descriptions of concerns or issues, and the server processes those descriptions to generate context-aware solution candidates.

The server uses general-purpose computing hardware, such as a central processing unit and optionally a graphics processing unit, installed in a data center or cloud computing environment. For example, the server may be implemented on a virtual machine provided by a generic cloud platform, where the central processing unit executes an operating system such as a general-purpose server operating system, and the graphics processing unit accelerates processing of a generative AI model. The storage device may include a non-transitory computer-readable medium such as a solid-state drive or a hard disk drive, on which a relational database management system, a model parameter file for a generative AI model, and application programs are stored.

The server executes application software implemented by a general-purpose server-side framework, such as a script-based web framework or a virtual machine-based web framework. The server configures a network stack to communicate with the terminal via a secure transport protocol over a packet-switched network. The terminal may be a handheld computing device running a mobile operating system or a personal computer running a desktop operating system. The terminal executes client software, such as a native application or a web browser, to render user interface components, accept user input in text form, and transmit the input to the server.

The server stores, in the storage device, one or more machine-readable models implementing a natural language processing technique and a generative AI model. In one embodiment, the natural language processing technique is realized by a transformer-based neural network model that has been pre-trained on a large corpus of natural language text and fine-tuned to perform classification of user concerns into predefined categories such as a health field, an exercise field, and a diet field. The generative AI model may share the same architecture or may be a separate transformer-based sequence-to-sequence model, having multiple layers of self-attention and feed-forward networks, with learned weight parameters stored in parameter tensors in the storage device.

The server loads model parameters from the storage device into main memory and into graphics processing unit memory, and the processor and graphics processing unit cooperate to execute matrix operations, attention calculations, and activation functions specified by the neural network architecture. The natural language processing technique uses tokenization logic to convert the user's text into a sequence of discrete tokens, maps the tokens to embedding vectors using an embedding matrix, and then passes the vectors through multiple attention heads in each transformer layer. The attention mechanism computes weighted sums over token representations based on similarity scores, thereby capturing long-range dependencies in the input information. This allows the server to identify subtle contextual cues in the user's description that a simple rule-based system would not capture.

The server stores, in the storage device, structured data representing related information. For example, the storage device may hold relational database tables that contain information about exercise recommendations, dietary patterns, and lifestyle suggestions. The tables may include columns such as a category identifier, a textual description, numerical parameters (e.g., recommended minutes per day of activity), and constraints (e.g., recommended calorie ranges). The server uses an indexing structure, such as a B-tree index, in the database to efficiently retrieve relevant records based on a category and keywords computed from the user's input.

The server maintains a specific data flow and module configuration to improve computational efficiency. The server implements separate modules for input reception, natural language analysis, database retrieval, prompt construction, AI inference, and output formatting. Each module uses well-defined data structures; for example, the natural language analysis module outputs a structured object that includes fields for a category label, a confidence score, and a short summary string. The server uses this structured object to construct parameterized database queries, thereby minimizing ad hoc text parsing and reducing the risk of erroneous or inefficient queries.

The server constructs a prompt sentence for the generative AI model that explicitly encodes the results of the analysis and the retrieved related information. The prompt sentence is not a static template; instead, the server dynamically assembles the prompt based on the category, the summary, the user's original text, and the content retrieved from the storage device. Because the server explicitly separates and structures this information, the server can optimize the length and composition of the prompt to satisfy both quality and latency constraints when calling the generative AI model.

In one specific example, the user inputs on the terminal the following natural language text: “Recently, my weight has been increasing and I am worried.”

The terminal transmits this text to the server via the communication device. The server uses the natural language processing technique to categorize the concern as related to weight management within the health field, and to generate a summary such as: “The user is concerned about recent weight gain.” The server then queries the storage device for information classified under a weight management category and retrieves, for example, a recommended exercise description and a recommended diet description.

Based on this information, the server constructs a prompt sentence such as:
“The user wrote: ‘Recently, my weight has been increasing and I am worried.’
Analysis result: category=weight_management.
Database information:
   Exercise plan: perform 30 minutes of daily aerobic exercise such as brisk walking or light jogging.
   Diet menu: eat meals with many vegetables, reduce sugary drinks, and control portion sizes.

Based on this information, please generate a concrete, personalized solution for the user. The solution must:
Propose a 1-week exercise schedule with specific daily activities.
Propose daily diet guidelines that are practical and easy to follow.
Use clear, concise language suitable for a non-expert user.”

The server inputs this prompt sentence into the generative AI model. The generative AI model, running on the processor and graphics processing unit, computes multiple transformer layers that integrate the contextual embedding of the user's concerns with the structured content from the database. Due to the attention mechanism and the explicit inclusion of categorized data, the generative AI model can generate an output that is significantly more specific and consistent than an output created from the user's text alone. The server receives the generated solution candidate as a sequence of tokens, decodes them into a natural language string, and transmits the resulting text to the terminal for display.

The server also generates a distinct first prompt sentence for the analysis operation, separate from the second prompt sentence for solution generation. In one example, the server uses the following first prompt sentence to guide the generative AI model when identifying a category and keywords:
“User's message: ‘Recently, I feel tired easily and I am in trouble.’
Please analyze this message and return the main problem category and a short summary in the following format:
Category: [category name]
Summary: [short summary]
Keywords: [comma-separated keywords].”

The server then parses the text output of this prompt into structured fields and uses those fields to drive database retrieval.

In another example, the server uses the following second prompt sentence for generating a concrete action plan:
“The user wrote: ‘Recently, I feel tired easily and I am in trouble.’
Analysis result: category=fatigue.
Database information:
   Recommended exercise: light daily exercise such as 30 minutes of walking.
   Recommended diet: increase intake of foods rich in vitamin B (whole grains, meat, eggs). Based on this information, please generate a concrete action plan for the user, including:
   A simple weekly schedule for exercise.
   Specific examples of meals and snacks that support recovery from fatigue.
Use clear, supportive language and keep the explanation within 400 words.”

The server's separation of the analysis prompt and the solution-generation prompt leads to a technical improvement in computational efficiency and accuracy. The server can reuse the analysis prompt for many users and adjust only the user text segment, which reduces the amount of dynamic prompt construction and improves cache locality for certain prompt segments stored in memory. Additionally, by limiting the role of each prompt to a specific sub-task, the server can more precisely constrain the output space of the generative AI model, which reduces processing time and lowers the probability of irrelevant or off-topic output. This structured interaction with the generative AI model improves the technical functioning of the server by enabling more predictable and resource-efficient inference.

The server further supports iterative refinement. When the user provides additional input information on the terminal, such as:
“I cannot go outside when it is raining. Can you suggest indoor exercises instead?”
the terminal transmits this additional input to the server. The server does not simply append this text to the previous prompt. Instead, the server re-applies the natural language processing technique to the additional input, identifies that the constraint “cannot go outside when it is raining” should modify the previously selected category and exercise plan, and executes a new database query to retrieve alternative exercise entries tagged as indoor activities. The server then constructs an updated prompt sentence that explicitly encodes the new constraint and the newly retrieved related information.

Because the server uses structured data for categories, constraints, and retrieved items, the server can avoid redundant re-analysis of unchanged portions of the context and instead focus resources on the incremental changes. This incremental processing reduces overall computation time and network traffic for repeated interactions, thereby lowering latency and communication load. The server's design thus provides a technical effect beyond mere automation of human reasoning; it optimizes the distribution of computation between the natural language analysis, database retrieval, and generative AI inference operations.

The generative AI model itself is implemented as a deep neural network trained on a corpus of text that includes examples of problem descriptions and corresponding advice. The server, during a training phase executed on separate hardware, uses a supervised learning method where the model's output is compared against reference responses using a loss function such as cross-entropy. The server computes gradients of the loss with respect to model weights using backpropagation and updates the weights using an optimizer such as stochastic gradient descent with adaptive learning rates. The server may also apply data augmentation by paraphrasing problem descriptions or adding synthetic variations of advice, improving the robustness of the model to varied user expressions.

During inference, the server uses a beam search or sampling algorithm with a configured temperature parameter to generate tokens from the generative AI model. The server can adjust parameters such as maximum token length and top-k sampling to manage computational load and control the determinism of outputs. By tuning these parameters based on category and context length, the server reduces unnecessary token generation and network transmission size, thereby increasing throughput and decreasing memory pressure on the server.

The server employs internal buffers and streaming mechanisms to send partial outputs to the terminal if desired, allowing the terminal to begin rendering the solution candidate while the remaining tokens are still being generated. This streaming behavior is controlled by timing and buffer size thresholds configured in the server, which lowers perceived latency for the user and makes more efficient use of the communication device's bandwidth.

The server also differs from a purely rule-based engine in that it applies non-conventional processing strategies. For example, the server may maintain a rule module that checks for category-specific safety or consistency constraints (such as avoiding recommendations that conflict with certain health conditions) before finalizing the solution candidate. The server applies these rules not as the primary decision mechanism but as a post-processing filter to the generative AI output, thereby combining the flexible reasoning capability of the neural model with deterministic constraints. This hybrid approach improves reliability and reduces the rate of technically inappropriate suggestions, which is a concrete technical improvement in the operation of the recommendation system.

In variations of this embodiment, the server may use different database structures, such as a document database storing related information as documents indexed by category and key terms, or a vector database storing embedding vectors derived from the related information, enabling approximate nearest-neighbor searches. In another variant, the natural language processing technique may be implemented not as a transformer but as a recurrent neural network or a convolutional network adapted for text. In all such variants, the server maintains the basic configuration of separating analysis prompts from solution-generation prompts, using structured retrieval from the storage device, and iteratively updating prompt sentences based on additional input.

The terminal may display the solution candidate in varied formats. The terminal can present text in a structured layout with headings, bullet points, and emphasis markers, and may additionally render graphical elements such as progress indicators for exercise completion or charts summarizing recommended diet distributions. The terminal may also send back interaction metadata, such as the user's rating of the usefulness of a suggestion, which the server can store in the storage device and use as feedback signals for future model fine-tuning.

The described configuration improves computer technology in several respects. The server reduces redundant computations by modularizing the analysis and generation tasks and by reusing structured analysis results across multiple interactions. The server decreases communication load by controlling prompt length and output length based on category and context. The server increases the accuracy and specificity of generated solutions by tightly integrating database retrieval with generative AI inference through carefully constructed prompt sentences. These improvements manifest as faster response times, lower resource utilization, and higher consistency of outputs compared to conventional systems that merely apply generic text generation to user input without structured retrieval and staged prompting.

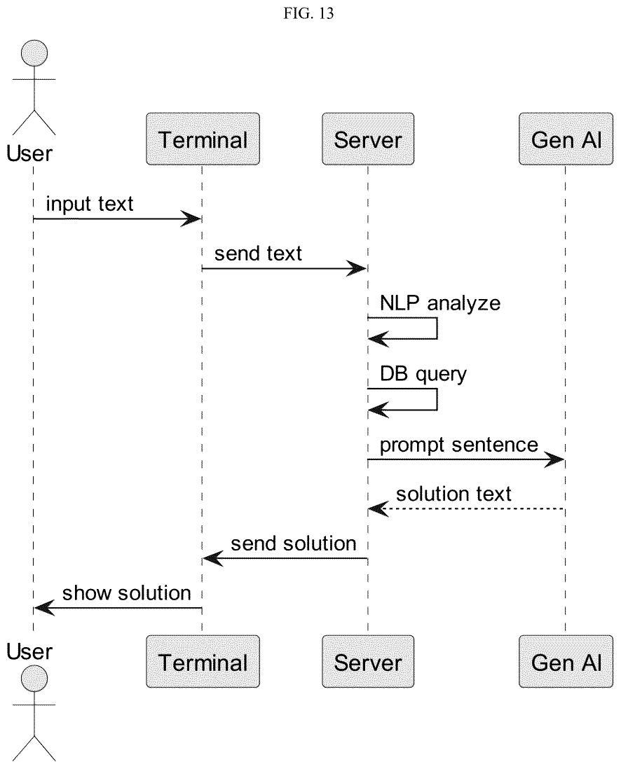

The following describes the processing flow using FIG. 13.

### Step 1:

The user operates the terminal to input a concern or issue in natural language. The user types free-form text, such as “Recently, my weight has been increasing and I am worried,” into a text input field displayed on the terminal's screen.

Input: Raw text characters entered by the user.

Output: A text string stored in the terminal's memory.

The terminal performs input validation, such as checking that the string is not empty and that its length does not exceed a predetermined limit. The terminal then encodes the text string using a character encoding scheme and prepares it as part of a structured data object.

### Step 2:

The terminal transmits the structured data object containing the user's text to the server. The terminal creates, for example, a request message comprising a user identifier and the text string, and sends this message to the server via a communication protocol.

Input: The text string and associated metadata (e.g., user identifier, timestamp) stored at the terminal.

Output: A network request containing the text string and metadata, delivered to the server.

The terminal uses its communication interface to encapsulate the data into network packets and forwards these packets to the server's network address.

### Step 3:

The server receives the network request from the terminal through the communication device. The server parses the request to extract the user's text and metadata.

Input: Network packets containing the user's text and metadata.

Output: An internal representation of the user's text and metadata in the server's memory. The server converts the encoded byte sequence back into a text string, normalizes the text (for example, by converting to a standard character form), and stores the normalized text and metadata in a temporary data structure for further processing.

### Step 4:

The server applies a natural language processing technique to analyze the user's text. The server uses a tokenizer to split the text into tokens and then maps each token to an embedding vector using a stored embedding matrix.

Input: The normalized text string representing the user's concern or issue.

Output: A set of analysis results including at least a category label, a summary sentence, and a list of keywords.

The server feeds the embedding vectors into a neural network model (such as a transformer-based model) that executes attention calculations and feed-forward operations on the processor and, optionally, a graphics processing unit. The server computes an output distribution over predefined categories and selects the category with the highest probability as the category label. The server also generates a condensed summary and extracts salient tokens as keywords. The server stores these analysis results as structured data in memory.

### Step 5:

The server generates and sends a database query to the storage device based on the category label and keywords.

Input: The structured analysis results, including the category label and keywords.

Output: A set of related information records retrieved from the storage device.

The server constructs a query condition, for example, “category=weight_management AND keyword IN ( . . . )” and issues the query to the database engine. The storage device searches indexed records and returns matching entries, such as exercise plans and diet guidelines. The server converts the database response into an internal list or map structure containing fields such as titles, descriptions, and numerical parameters.

### Step 6:

The server constructs a first prompt sentence for analysis (if a generative AI model is used at this stage) or uses the existing analysis output, and constructs a second prompt sentence for solution generation.

Input: The user's original text, the category label, the summary, the keywords, and the related information retrieved from the storage device.

Output: One or more prompt sentences formatted as natural language text.

The server concatenates fixed instruction segments and variable segments derived from the analysis results and database records. For example, the server may construct the following second prompt sentence:
“The user wrote: ‘Recently, my weight has been increasing and I am worried.’ Analysis result: category=weight_management.
Database information:
   Exercise plan: perform 30 minutes of daily aerobic exercise such as brisk walking or light jogging.
   Diet menu: eat meals with many vegetables, reduce sugary drinks, and control portion sizes.

Based on this information, please generate a concrete, personalized solution for the user.

The solution must:
Propose a 1-week exercise schedule with specific daily activities.
Propose daily diet guidelines that are practical and easy to follow.
Use clear, concise language suitable for a non-expert user.”

The server stores the constructed prompt sentences in memory for use in the next step.

### Step 7:

The server sends the appropriate prompt sentence to the generative AI model and causes the model to perform inference.

Input: A prompt sentence containing the user's text, analysis results, and related information. Output: A generated solution candidate in the form of a sequence of tokens that can be decoded into a natural language string.

The server encodes the prompt sentence into tokens using a tokenizer associated with the generative AI model, then passes the token sequence to the model. The generative AI model, implemented as a multi-layer neural network, performs a series of matrix multiplications, attention weight calculations, non-linear activation functions, and normalization operations. The server iteratively computes logits for the next token, applies a decoding strategy (such as beam search or sampling), and accumulates tokens until a termination condition is met (e.g., an end-of-sequence token or a maximum length). The server decodes the token sequence into a text string representing the solution candidate and stores it in memory.

### Step 8:

The server optionally post-processes the generated solution candidate before sending it to the terminal.

Input: The raw generated text string produced by the generative AI model.

Output: A cleaned and formatted solution text string ready for transmission.

The server performs operations such as trimming leading and trailing whitespace, removing unintended repeated phrases, and structuring the text into paragraphs or bulleted lists if necessary. The server may also execute rule-based checks to ensure that the solution candidate conforms to predefined constraints (for example, avoiding obviously inconsistent or unsafe recommendations). The server then wraps the processed solution text and associated metadata (such as the category label) into a response object.

### Step 9:

The server transmits the processed solution candidate to the terminal.

Input: The response object containing the solution text and metadata.

Output: A network response message delivered from the server to the terminal.

The server serializes the response object into a transmission format, encapsulates it in network packets, and sends the packets via the communication device to the terminal's network address.

### Step 10:

The terminal receives the network response from the server and extracts the solution candidate.

Input: Network packets containing the response object from the server.

Output: A solution text string and associated metadata available in the terminal's memory.

The terminal decodes the received bytes, reconstructs the response object, and obtains the solution text and category information. The terminal then prepares the solution text for display by applying user interface formatting rules, such as setting font size, line spacing, and layout.

### Step 11:

The terminal displays the solution candidate to the user.

Input: The formatted solution text and category information.

Output: A visual representation of the solution candidate on the terminal's display.

The terminal renders the text on the screen, optionally dividing it into labeled sections such as “Exercise Plan” and “Diet Guidelines.” The user reads the displayed content and may choose to follow the recommendations or provide further input.

### Step 12:

The user optionally provides additional input based on the displayed solution, and the terminal sends this additional input to the server.

Input: New natural language text from the user, such as a follow-up question or a constraint. Output: An updated request message containing the additional input, transmitted to the server.

The terminal captures the new text, validates it, and packages it together with context identifiers (e.g., a session identifier) so that the server can associate the additional input with the prior interaction.

### Step 13:

The server receives the additional input and performs iterative refinement of the solution candidate.

Input: The additional input text and context identifiers indicating the previous interaction. Output: An updated solution candidate that reflects both the original concern and the additional constraints or clarifications.

The server re-applies the natural language processing technique to the additional input, updates the structured analysis results (for example, by adding a constraint such as “indoor exercise only”), and re-queries the storage device for new or modified related information.

The server then generates an updated prompt sentence that includes both the original context and the new constraint, such as:
“The user originally wrote: ‘Recently, my weight has been increasing and I am worried.’ The user additionally wrote: ‘I cannot go outside when it is raining. Can you suggest indoor exercises instead?’
Analysis result: category=weight_management, constraint=indoor_exercise.
Database information:
   Indoor exercise plan: perform 30 minutes of light aerobic exercise at home, such as stepping exercises or stationary cycling.
   Diet menu: eat meals with many vegetables, reduce sugary drinks, and control portion sizes. Based on this information, please generate an updated, personalized solution for the user that only includes indoor exercises.”

The server inputs this updated prompt sentence into the generative AI model, generates a revised solution candidate, and sends it to the terminal as in the previous steps, thereby iteratively improving the solution based on the user's additional input.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented support systems that attempt to assist users with health management, behavior change, and emotional well-being typically rely on static rule sets or simple pattern matching. Such systems usually treat sensor data, textual input, and emotional state in isolation, and do not exploit these heterogeneous data streams in an integrated manner when generating machine-learned recommendations. As a result, the systems often generate generic, poorly personalized advice, and exhibit limited ability to adapt over time to individual user responses.

Furthermore, existing systems that employ machine learning or artificial intelligence models generally use fixed prompts or input formats for such models. The prompt sentences are usually handcrafted and remain static regardless of the effectiveness of prior outputs. Because the systems do not capture and analyze the relationships among user behavior histories, emotional changes, prompts, and model outputs, the systems cannot systematically refine the prompts or model inputs. This leads to suboptimal utilization of generative artificial intelligence models, reduced computational efficiency, and degraded relevance of generated solutions.

Additionally, many known systems lack a robust feedback loop at the system level. While they may log whether a user has received a suggestion, they do not rigorously track execution status, continuation rates, subjective evaluations, and their correlation with particular prompt formats and model outputs. Without such correlation, the underlying computational pipeline—ranging from data acquisition, feature generation, prompt construction, model invocation, solution selection, and user presentation—cannot be algorithmically tuned. Consequently, the system is unable to improve the suitability and effectiveness of generated solutions as more data is accumulated.

Therefore, there is a need for a computer-implemented system that (i) integrates heterogeneous time-series sensor data and language inputs into unified feature representations, (ii) dynamically constructs context-aware prompt sentences for generative artificial intelligence models, and (iii) continuously optimizes those prompts and associated solution selection logic based on detailed execution results and emotional state changes. Such a system should improve the operation of the underlying computing platform by enhancing the relevance, adaptivity, and efficiency of AI-generated solutions, rather than merely automating human decision-making.

The specific processing by the specific processing unit 290 of the data processing device 12 in Application Example 2 is realized by the following means.

The present invention provides a server comprising a processor configured to acquire time-series behavior information, utterance information, biological information, and environmental information of a user from multiple sensor devices and terminal devices; to perform preprocessing and normalization on the acquired time-series information to calculate, for each unit time, activity amounts, movement distances, heart rates, energy expenditure amounts, emotion estimation results, and health indicators, and to generate feature information representing a state of the user; to execute natural language processing on user input text information or speech recognition results and on the feature information so as to extract keyword information and category information related to concerns, issues, and desires of the user; to generate, based on the feature information, the category information, and emotion analysis results, context information and to automatically generate a prompt sentence specifying at least a task content, an output format, and a constraint condition for a generative artificial intelligence model on the basis of the context information, and to input the prompt sentence into the generative artificial intelligence model; to obtain text information output from the generative artificial intelligence model, to estimate and determine the concerns and the issues of the user based on the text information, and, according to types of the concerns and the issues, to search a solution candidate database in a data storage device so as to extract solution candidates, calculate suitability degrees of the solution candidates based on attribute values of the solution candidates and the feature information, and select at least one of the solution candidates; to edit the selected solution candidate into a presentation format suitable for the user and present the edited solution candidate to the user via a terminal device; and to acquire, from the terminal device, execution status and subjective evaluation by the user with respect to the selected solution candidate, to record the execution status and the subjective evaluation as execution result information including at least a completion rate, a continuation rate, and an evaluation value, and to update the feature information and generation conditions of the prompt sentence based on the execution result information so as to optimize contents of input to the generative artificial intelligence model for subsequent processing. This enables the underlying computer system to dynamically adapt the structure and content of prompts and solution selection logic in response to actual user behavior and emotional changes, thereby improving the technical performance of the generative artificial intelligence pipeline, enhancing the relevance and effectiveness of generated solutions, and providing a more efficient and automatically self-optimizing computational framework than conventional static AI-driven support systems.

The term “sensor device” refers to a hardware component configured to detect and output physical or physiological quantities, such as motion, position, heart rate, temperature, sound, or images, as electrical or digital signals.

The term “terminal device” refers to a user-operated computing apparatus, such as a mobile terminal, a wearable apparatus, or a personal computing apparatus, that is configured to present information to a user and to transmit user-related data to a server.

The term “time-series data” refers to data values associated with respective points or intervals in time, generated sequentially and including, for example, sequences of sensor measurements or user interactions recorded with timestamps.

The term “behavior information” refers to information representing actions or activities of a user, including, for example, movement patterns, exercise activities, operation histories of applications, and interaction histories with services.

The term “utterance information” refers to information derived from spoken or written expressions of a user, including, for example, transcribed speech, text messages, and other language-based inputs.

The term “biological information” refers to information representing physiological states of a user, such as heart rate, respiratory rate, body temperature, and other biometric indicators. The term “environmental information” refers to information representing conditions of an environment surrounding a user, such as location, ambient temperature, ambient noise level, or lighting conditions.

The term “preprocessing” refers to computational operations that transform raw data into a format suitable for analysis, including at least noise reduction, unit conversion, resampling, aggregation, and normalization.

The term “normalization” refers to a process of adjusting numerical data to a common scale or representation so that heterogeneous data can be compared or combined in a unified manner.

The term “activity amount” refers to a quantitative measure of a user's physical activity over a unit time, including, for example, step counts, motion intensity, or exercise duration.

The term “movement distance” refers to a spatial length value computed from position-related data, representing how far a user has moved within a unit time.

The term “heart rate” refers to a numerical value indicating the number of heartbeats per unit time, typically expressed in beats per minute.

The term “energy expenditure amount” refers to an estimated quantity of energy consumed by a user during physical activity within a unit time, generally expressed in caloric units. The term “emotion estimation result” refers to data representing one or more inferred emotional states of a user, each state being associated with at least an emotion label and an intensity value.

The term “health indicator” refers to a computed metric that quantitatively represents an aspect of a user's health condition, such as body mass index, stress index, activity balance index, or sleep quality index.

The term “feature information” refers to structured data derived from raw inputs, including numerical values and categorical labels, that collectively represent a state or characteristics of a user and are suitable for further computational processing.

The term “natural language processing” refers to a group of computational techniques for analyzing and processing human language data, including at least tokenization, morphological analysis, syntactic analysis, semantic analysis, and sentiment or emotion analysis.

The term “morphological analysis” refers to processing that divides a text into morphemes or words and assigns grammatical attributes such as part-of-speech tags.

The term “syntactic analysis” refers to processing that determines grammatical structure of a sentence, including relationships among words such as dependencies or phrase structures. The term “emotion analysis” refers to processing that determines an emotional polarity or state contained in text, including, for example, degrees of positivity, negativity, stress, anxiety, or joy.

The term “topic extraction” refers to processing that identifies main subjects, themes, or domains discussed in text by extracting representative words, phrases, or topic categories. The term “keyword information” refers to one or more words or phrases selected from text as being particularly relevant to user concerns, issues, or desires.

The term “category information” refers to one or more classification labels indicating types of user concerns, issues, or desires, such as health-related, work-related, relationship-related, or lifestyle-related categories.

The term “context information” refers to combined information representing a current situation of a user, including at least feature information, category information, emotion analysis results, and optionally historical records.

The term “prompt sentence” refers to a text string that specifies an instruction, context, and constraints for a generative artificial intelligence model, and that is used as input to control the model's output behavior.

The term “generative artificial intelligence model” refers to a parameterized computational model configured to generate output data, such as text, based on input data including a prompt sentence, using techniques such as machine learning or deep learning.

The term “text information” refers to character-based data output from a generative artificial intelligence model, including, for example, explanations, assessments, recommendations, and action suggestions.

The term “concerns” refers to states or matters that a user subjectively regards as problematic or worrisome and that the system seeks to identify and address.

The term “issues” refers to objective or semi-objective problem situations related to a user's behavior or condition that can be inferred and defined by the system for the purpose of proposing solutions.

The term “desires” refers to goals, wishes, or preferred outcomes expressed or inferred for a user, such as improvement of health, stress reduction, or achievement of particular performance targets.

The term “solution candidate database” refers to a data storage structure that stores multiple solution candidate records, each record describing at least one potential action, recommendation, or resource for addressing a user concern or issue.

The term “solution candidate” refers to a stored candidate for a recommendation, including at least a description, attribute values, and classification information, which can be selected and presented to a user.

The term “attribute value” refers to a data item associated with a solution candidate, such as applicable user category, required time, intensity level, resource type, nutritional value, or cost.

The term “suitability degree” refers to a numerical or ordinal value representing a degree of match between a solution candidate and feature information of a user, computed by comparing attribute values of the candidate with user state representations.

The term “presentation format” refers to a layout or structure in which information is output to a user, including at least text segments, headings, emphasis, and optional links or controls for executing actions.

The term “execution status” refers to information indicating how a user has performed a provided solution candidate, including at least whether the solution was started, in progress, completed, or discontinued.

The term “subjective evaluation” refers to user-provided assessment data, such as ratings, comments, or self-reported impressions, associated with a solution candidate or its outcome. The term “execution result information” refers to data summarizing both objective execution status and subjective evaluation for a solution candidate, including at least completion rate, continuation rate, and evaluation value.

The term “generation conditions of the prompt sentence” refers to parameters, rules, or templates that determine how context information is transformed into a specific prompt sentence for a generative artificial intelligence model.

The term “action plan” refers to a structured description of one or more actions that a user is recommended to take, such as a sequence, schedule, or combination of health-related or behavior-related tasks.

The term “health management menu” refers to an action plan or set of items relating to food intake, nutrition, rest, or other health-supporting activities for a user.

The term “physical activity program” refers to an action plan for physical exercises, movements, or training sessions, including at least exercise type, duration, intensity, and frequency.

The term “psychological burden reduction method” refers to a technique or process designed to reduce mental stress or emotional strain of a user, such as relaxation exercises, breathing techniques, or cognitive coping strategies.

The term “provision management apparatus” refers to an information processing apparatus configured to manage provision of goods or services to a user, including at least a distribution management apparatus or a service provision management apparatus.

The term “distribution management apparatus” refers to an apparatus that manages logistics or delivery processes for goods, including ordering, shipment, tracking, and delivery status management.

The term “service provision management apparatus” refers to an apparatus that manages provisioning of intangible services, including scheduling, allocation, activation, and completion tracking of service instances.

The term “provision status” refers to information indicating a current state of provision of a good or service associated with an action plan, such as ordered, in preparation, dispatched, in progress, or completed.

The term “behavior record” refers to a stored history of user activities over time, derived from sensor data, usage logs, or explicitly recorded actions.

The term “emotional state” refers to a state of a user's emotion at a given time, represented by one or more emotion labels and associated intensity values.

The term “correspondence relationship” refers to an association mapping among behavior records, emotional state changes, prompt sentences, and outputs of a generative artificial intelligence model.

The term “components of the prompt sentence” refers to constituent parts of a prompt, such as an instruction segment, a context segment, constraint specifications, and formatting directives.

The term “instruction contents” refers to directives contained within a prompt sentence that define what task the generative artificial intelligence model should perform.

The term “constraint conditions” refers to limitations or rules specified in a prompt sentence that restrict or guide the generative artificial intelligence model's output, such as length limits, style constraints, or content exclusions.

The term “suitability of solutions” refers to a degree to which generated solutions match user needs and states, as determined by objective and subjective outcome measures.

The term “effectiveness of solutions” refers to a degree to which generated solutions lead to desired changes in user behavior, health indicators, or emotional states.

In one embodiment, a server cooperates with at least one terminal and at least one sensor device to implement the claimed system. The server comprises a processor, a main memory, a nonvolatile storage device, and a network interface. The server executes software components including an operating system, a web server, an application server, a database management system, and an artificial intelligence engine implementing a generative AI model. The terminal comprises a processor, a memory, a display, an input interface, a communication interface, and one or more integrated sensors such as a camera, a microphone, a motion sensor, a positioning sensor, and a biometric sensor. The sensor device can be integrated into the terminal or can be provided as an external wearable device such as a wristband or a watch.

The server uses general-purpose software components to implement the functions of the system. The server uses, for example, a relational database management system such as a structured query language database to store user profiles, sensor data, feature information, prompt sentences, and generative AI outputs. The server uses a machine learning framework such as a deep learning library to implement a generative AI model and associated neural networks. The server uses a natural language processing library such as a text processing framework to perform tokenization, part-of-speech tagging, dependency parsing, and sentiment analysis. The terminal uses, for example, a cross-platform mobile application framework to implement an application that renders user interfaces and communicates with the server.

The server stores and executes a generative AI model that is implemented as a multi-layer neural network. In one embodiment, the generative AI model is a transformer-based language model including a plurality of attention blocks arranged in depth, each block including a multi-head self-attention layer and a position-wise feed-forward layer. The server stores, for each attention block, weight matrices for query, key, and value projections, and parameters for normalization layers. The server uses these parameters to compute attention scores over token sequences derived from prompt sentences. The server uses a cross-entropy loss function during training of the generative AI model and updates the parameters by backpropagation and gradient descent using a variant such as the Adam optimizer. The server may pretrain the generative AI model on a large corpus and further fine-tune the model using domain-specific interactions captured by the system.

The server defines a data structure for sensor data as a time-indexed table containing, for each record, at least a user identifier, a timestamp, a sensing modality identifier, and one or more numerical values. The server defines a data structure for feature information as a vector with fixed dimension, for example, a floating-point array of length N, where each element represents a normalized quantity such as step count per minute, average heart rate, estimated energy expenditure, emotion score, or a transformed environmental parameter. The server defines a data structure for category information and keyword information as a set of integer or string labels mapped to ontological categories. The server defines a data structure for a prompt sentence as a text field together with metadata describing the template used, the included context fields, and the purpose of the prompt.

The server uses dedicated software modules to perform data processing and computational operations that are not conventional in generic data collection systems. The server implements a feature extraction module that converts raw time-series data into feature information. The feature extraction module aggregates sensor data over sliding windows, applies smoothing filters such as exponential moving averages, and normalizes the values by user-specific baselines and population statistics. The server thereby reduces noise and standardizes heterogeneous signals, which improves both numerical stability and predictive accuracy of downstream computations.

The server implements a natural language processing module that consumes user utterance information and converts it into structured semantic representations. The server uses a tokenizer to split text into tokens, a tagger to assign part-of-speech tags, and a dependency parser to determine syntactic relations. The server uses an emotion classifier, implemented as a recurrent neural network or transformer-based classifier, to assign emotion labels such as stress, joy, sadness, and their intensities. The server uses topic modeling techniques such as latent Dirichlet allocation or supervised topic classifiers to assign problem domain categories. The server stores these outputs as category information and keyword information associated with each interaction.

The server implements a prompt construction module that transforms context information into a prompt sentence for the generative AI model. Context information includes feature information, category information, emotion analysis results, and historical indicators such as execution success rates for previous solutions. The server uses a rule-based template engine to select and assemble prompt components; this is not a mere static template but a decision system that modifies prompt composition parameters based on accumulated statistics. For example, the server shortens or lengthens target output length, changes the requested style, or adjusts the level of detail depending on the user's reading behavior and previous adherence. The server uses the prompt construction module to generate a prompt sentence in plain text, such as:
“User text: ‘I feel tired and stressed about work.’
Health data: age 35, body mass index 27, average steps per day 4500, average sleep 6 hours.
Emotion: stress high, sadness medium.
Task: as a health and wellness coach, infer the user's main worries and generate one short empathetic response plus one practical, easy-to-do suggestion for today.”

The server may generate other prompt sentences, such as:
“Based on the following user health information, propose three optimal daily meal menus including calories and macronutrient breakdown. The user is currently on a diet and wants low-calorie meals: age 35, height 170 cm, weight 75 kg, goal weight 68 kg, light exercise three times per week, no seafood, allergic to peanuts.”
or
“From the following user utterance and the detected emotion ‘stress’, infer likely underlying concerns and generate a brief, empathetic response plus one practical recommendation: ‘Recently, I feel tired every day and can't focus on my work.’”

The server uses these prompt sentences to control behavior of the generative AI model and to extract from the model outputs that are structurally aligned with the solution candidate database.

In one embodiment, the server implements a solution selection module that compares outputs of the generative AI model with structured solution candidates stored in a database. Each solution candidate includes attribute values such as applicable emotion state, required execution time, physical intensity level, resource type, and estimated impact on health or emotional state. The server computes a suitability degree by comparing feature information to these attribute values. The server uses a scoring function that may combine weighted Euclidean distance, cosine similarity, or learned ranking scores from a separate neural ranking model. The server selects the highest-scoring solution candidates for presentation. The terminal presents the selected solution candidate to the user in a format determined by the presentation module in the server. The terminal may display textual explanations, step-by-step instructions, and interactive controls that trigger further actions, such as starting an exercise program or placing an order for a meal. The terminal collects interaction events such as button presses, scrolls, and time spent on specific views, and sends these events to the server as user behavior information, which the server uses to refine its internal models.

The server implements a feedback integration module that analyzes execution status and subjective evaluations. The server records completion rate, continuation rate, and evaluation value for each solution candidate provided to the user. The server computes aggregated metrics, such as average rating per solution type, probability of completion given a particular prompt template, and changes in emotion estimation before and after solution execution. The server uses these aggregated metrics to adjust parameters that control prompt construction and solution candidate ranking.

The server thereby configures the generative AI model and the overall data processing pipeline to operate in a self-optimizing manner. The server does not simply automate a human expert's manual decision-making. Instead, the server reorganizes internal data structures and prompt configuration parameters based on formal statistical relationships between prompts, model outputs, user actions, and emotional transitions. The server thereby improves technical performance of the computing system in several ways:

(1) The server reduces processing latency by precomputing feature information and caching frequently used context representations, so that only a small, focused prompt needs to be sent to the generative AI model instead of transmitting large amounts of raw sensor data.

(2) The server improves solution relevance and reduces error by dynamically modifying prompts and scoring functions based on observed effectiveness. For example, if a particular prompt format leads to low completion rates, the server reduces its usage probability, which directly decreases the expected number of ineffective outputs generated by the AI model.

(3) The server reduces communication load between terminal and server by compressing raw sensor data into aggregated feature vectors and by transmitting only minimal identifiers for solution candidates instead of full content, which is stored locally on the server. This reduces packet size and frequency.

(4) The server improves storage efficiency and query performance by indexing feature information and solution candidates with specialized data structures, such as multi-dimensional indexes for numerical features and inverted indexes for categorical attributes. In another embodiment, the server uses a mixed expert architecture where separate submodels are trained for different domains such as nutrition, exercise, and stress management. The server uses the context information to select a subset of experts and constructs a prompt sentence that routes the task to an appropriate expert submodel. This reduces computation and increases accuracy compared to a monolithic model that must cover all domains uniformly.

In a further embodiment, the server uses a reinforcement learning scheme to refine prompt generation rules. The server treats prompt template selection and parameterization as actions, treats outcomes such as completion rate and evaluation value as rewards, and uses a policy update algorithm such as a bandit algorithm or Q-learning to optimize action selection. The server thus implements a non-conventional, technical feedback loop over generative AI prompt structures, which is not merely manual tuning by a human operator.

The terminal uses its hardware sensors to capture user conditions in real time. For example, the terminal uses an accelerometer and a gyroscope to measure steps and motion intensity, a positioning sensor to measure distance traveled, and a heart rate sensor to measure biological responses. The terminal uses a camera and a microphone to capture facial expressions and voice, which can be analyzed for emotion. The server uses this multimodal data to derive feature information that is more precise and responsive than manual, text-only inputs, thereby enabling more accurate estimation of user state and better-aligned recommendations.

The server also uses the terminal to control external apparatus indirectly, such as a distribution management apparatus or a service provision management apparatus. For example, the server sends an order instruction to an external distribution system to deliver a meal that matches a selected health management menu. The server monitors order status and updates the terminal with messages such as “accepted,” “preparing,” “out for delivery,” and “delivered.” By integrating this control loop, the system is not limited to abstract advice but drives concrete machine operations in the physical world.

In one example, the user operates the terminal to report that the user feels fatigue and stress after work. The terminal sends this utterance information and current activity metrics to the server. The server converts the utterance into tokens and computes an emotion estimation result of high stress. The server aggregates the day's sensor data into feature information indicating low activity and elevated heart rate. The server generates a prompt sentence that includes these values and instructs the generative AI model to propose a single short relaxation intervention suitable for the current context. The generative AI model responds with a text describing a breathing exercise. The server selects a stored breathing exercise solution candidate, adapts its description, and sends it to the terminal. The user follows the steps while the terminal records heart rate changes. The server then determines that heart rate decreased and that the user rated the intervention positively. The server records this outcome and increases the weight of breathing exercises in its solution ranking logic when stress-related episodes recur. This chain of interactions demonstrates that the system not only interprets data but also modifies internal computational parameters based on measured physical responses.

In another example, the user supplies health information and dietary preferences through the terminal. The server uses stored feature information and category information to construct a prompt sentence asking the generative AI model to generate three candidate meal plans. The generative AI model produces textual descriptions including calorie and macronutrient values. The server cross-references these descriptions with entries in a structured meal plan database to identify actual menus that match the model's textual constraints. The server uses a ranking algorithm that considers tolerance constraints such as allergens and target calorie ranges. The terminal displays the ranked list, and the user selects a meal. The server then initiates an order with an external distribution system and monitors delivery. The system thereby ties abstract nutritional reasoning to concrete logistics operations and physical delivery.

Alternative embodiments can vary software frameworks, machine learning architectures, or sensor configurations while remaining within the scope of the claims. For example, the generative AI model can be implemented as a recurrent neural network with attention, a convolutional sequence model, or another autoregressive language model architecture. The emotion analysis component can use a support vector machine, a gradient boosting machine, or a shallow neural network instead of a transformer-based classifier. The feature information can include additional dimensions such as sleep duration or environmental noise level. The scoring function for suitability degrees can employ different distance measures, learned ranking models, or rule-based heuristics.

The server can be deployed in a cloud computing environment, where multiple physical or virtual servers share responsibility for database management, AI computation, and communication. The terminal can be a smartphone, a tablet, a wearable device, or a personal computer, as long as it can send and receive data and can present information to the user. The sensor device can be integrated or external, as long as it can measure physical, physiological, or environmental quantities and send the results to the server.

In each embodiment, the server, the terminal, and the sensor device cooperate to implement the system in a way that improves operation of the computing platform itself. The server reorganizes how heterogeneous data are represented, how prompts are constructed, and how model outputs are used, and the server adapts these processes through automatic, data-driven adjustments. This degree of integration and adaptation, particularly with respect to generative AI prompt sentence design and solution candidate ranking based on measured effectiveness, enables improvements in accuracy, speed, storage efficiency, and communication load that are not obtainable through manual or static rule-based human procedures alone.

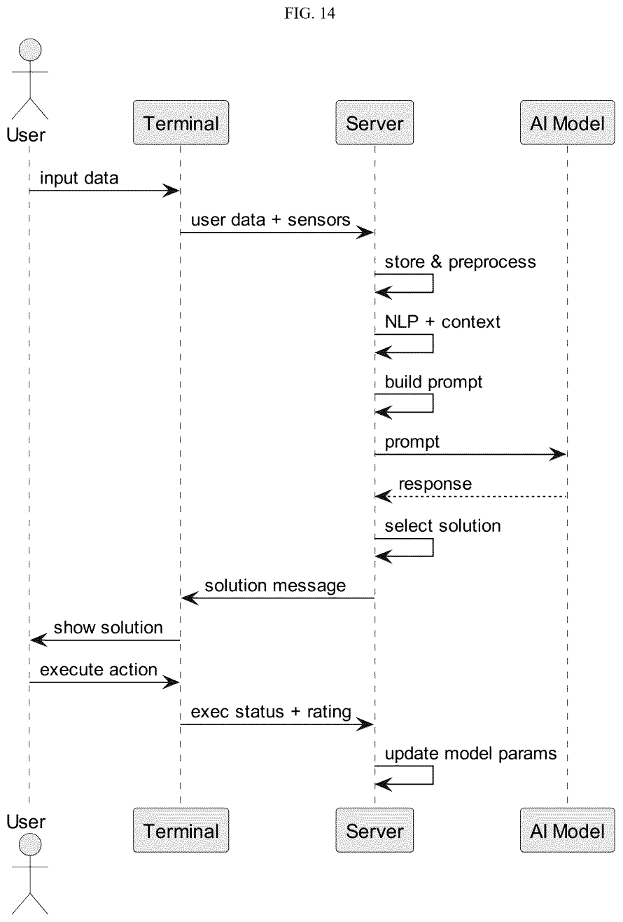

The following describes the processing flow using FIG. 14.

### Step 1:

Terminal displays an input interface and acquires raw user data.

Terminal shows input fields and controls for user profile items (age, height, weight), health goals, preferences, free-text concerns, and permissions for sensor access.

User enters text (e.g., “I feel tired and stressed about work”) and profile values, and optionally speaks into the microphone.

Terminal, when receiving a voice input, uses a speech recognition function to convert audio into text.

Input: raw keystrokes, touch events, and optional audio signals from User.

Terminal converts these into structured key-value pairs and text strings, performs basic validation (type checking, required fields), and outputs a structured request object containing user identifiers, profile data, and utterance text.

### Step 2:

Terminal acquires time-series sensor data and aggregates them.

Terminal activates sensors such as accelerometer, gyroscope, position sensor, and heart rate sensor according to user permissions.

Terminal periodically reads raw sensor values (e.g., every second) from the operating system sensor APIs.

Input: low-level sensor readings (acceleration vectors, GPS coordinates, heart rate samples) with timestamps.

Terminal performs data aggregation by computing simple statistics over fixed intervals (e.g., sum of steps, distance from GPS, average heart rate per minute), and outputs compact activity records that contain timestamped metrics such as steps/minute, distance, and average heart rate.

### Step 3:

Terminal packages and transmits user data and sensor data to the server.

Terminal merges the structured request object from Step 1 and the aggregated activity records from Step 2 into a single payload.

Terminal encodes the payload as a JSON document and attaches authentication information such as a token.

Input: structured profile data, utterance text, and aggregated activity metrics.

Terminal constructs an HTTPS request, writes the JSON into the body, and outputs the HTTP message to the communication interface, transmitting it to the server.

### Step 4:

Server receives the transmitted data and stores them in persistent storage.

Server accepts the HTTPS request, verifies the authentication token, and parses the JSON body.

Input: JSON payload containing user profile, utterance text, and activity metrics.

Server maps JSON fields to internal data structures and executes database operations (INSERT or UPDATE) on tables for user profiles, utterances, and activity logs.

Server computes initial derived values such as body mass index from height and weight and stores these along with raw inputs, and outputs normalized records written into storage.

### Step 5:

Server performs preprocessing and normalization of time-series sensor data.

Server retrieves newly stored activity logs for the current user and groups them by time windows (e.g., per 5 minutes or per hour).

Input: raw or lightly aggregated activity records with timestamps and sensor modality identifiers.

Server calculates, for each window, total steps, total distance, mean and maximum heart rate, and estimated energy expenditure using predefined formulas, then normalizes these metrics by user-specific baselines or population averages.

Server outputs feature vectors for each time window, where each vector contains normalized numerical values representing activity amount, movement distance, heart rate statistics, and energy expenditure.

### Step 6:

Server analyzes utterance text using natural language processing.

Server fetches the latest utterance text associated with the user from the database.

Input: raw text string, such as “I feel tired and stressed about work.”

Server tokenizes the text, assigns part-of-speech tags, and applies syntactic parsing to identify phrase structures.

Server applies sentiment and emotion classifiers to compute polarity and emotional intensity scores, and applies topic or category classifiers to assign domain labels such as “work stress” or “health.”

Server outputs keyword information (e.g., “tired”, “stressed”, “work”), category information, and emotion scores.

### Step 7:

Server combines sensor-based features and language-based features into context information. Server loads the feature vectors from Step 5 and the language analysis results from Step 6 for a consistent time range.

Input: numerical feature vectors (activity, heart rate, etc.) and symbolic features (keywords, categories, emotion scores).

Server performs feature fusion by concatenating or statistically summarizing the numerical vectors and attaching categorical labels, generating a unified context record that describes the current physical and emotional state of the user.

Server stores this record as context information in a context table and outputs a context object that will be used to construct a prompt sentence.

### Step 8:

Server constructs a context-aware prompt sentence for the generative AI model.

Server invokes a prompt construction module that receives the context object, including feature information, category information, and emotion analysis results.

Input: context object with user state (e.g., high stress, low activity, “work stress” category) and historical data about past interventions and success rates.

Server selects a prompt template based on the recognized category and modifies template parameters (e.g., desired length, tone, level of detail) according to historical success metrics. Server fills the template with concrete values from the context (age, activity levels, sleep, keywords) and generates a textual prompt sentence, such as:
“User text: ‘I feel tired and stressed about work.’
Health data: age 35, body mass index 27, average steps per day 4500, average sleep 6 hours.
Emotion: stress high, sadness medium.
Task: as a health and wellness coach, infer the user's main worries and generate one short empathetic response plus one practical, easy-to-do suggestion for today.”

Server outputs the constructed prompt sentence as a text string.

### Step 9:

Server sends the prompt sentence to the generative AI model and obtains a response. Server provides the prompt sentence to a generative AI model implemented as a multi-layer neural network, such as a transformer-based language model.

Input: tokenized version of the prompt sentence.

Server performs forward propagation through the model: it embeds tokens into vectors, computes multi-head self-attention across tokens, passes results through feed-forward layers, and finally generates probability distributions over output tokens at each step.

Server samples or selects output tokens according to these probabilities, constructs a response text, and returns it as model output.

Server outputs the generated text information, which typically includes an empathetic message and a recommended action.

### Step 10:

Server interprets the generative AI output and identifies required solution type.

Server parses the generated text and applies pattern matching or classification rules to determine whether the output suggests, for example, a relaxation exercise, a physical activity recommendation, a dietary suggestion, or another type of solution.

Input: generated response text from the generative AI model.

Server extracts key instructions and constraints (e.g., “3-minute breathing exercise,” “low-calorie dinner”) and maps them to internal solution categories.

Server outputs a structured representation of the AI's recommendation, indicating type, duration, and other attributes.

### Step 11:

Server retrieves candidate solutions from a structured solution database.

Server queries a database of pre-defined solution candidates, using the solution type and constraints from Step 10 as query conditions.

Input: solution type and attributes derived from AI output and context (e.g., “relaxation”, short duration, low effort).

Server executes database queries that select candidates matching the category and practical constraints, and calculates a suitability score for each candidate by comparing the candidate's attribute values with the user's feature information (e.g., matching intensity to current physical state, avoiding conflicts with allergies).

Server outputs a ranked list of solution candidates, each with a suitability degree.

### Step 12:

Server selects an optimal solution candidate and prepares a user-facing message.

Server chooses one or several top-ranked solution candidates based on the suitability scores and, optionally, diversity criteria.

Input: ranked list of solution candidates with suitability degrees.

Server merges candidate-specific details with the generative AI's textual guidance to create a coherent message that includes explanation and step-by-step instructions.

Server formats the message into a presentation format, adding headings, bullet points, and action labels suitable for rendering on the terminal, and outputs a finalized message object.

### Step 13:

Terminal receives the message and presents the selected solution to the user.

Terminal obtains the message object from the server via the network interface.

Input: structured message including textual explanation, instructions, and metadata about type and importance.

Terminal parses the message and renders the content on the display, for example as a card labeled “Today's suggestion” with an empathetic sentence and a “Start exercise” button. Terminal may also activate audio output or vibration feedback when appropriate, and outputs a visual and/or audible presentation that the user can perceive and interact with.

### Step 14:

User executes the suggested solution and terminal tracks execution status.

User reads the message and decides to perform the suggested action, such as following a breathing exercise or going for a short walk.

User taps the “Start” button on the terminal when beginning the activity and taps “Finish” when done, or the terminal auto-detects completion based on sensor readings.

Input: user interaction events and ongoing sensor measurements during execution.

Terminal monitors relevant sensors (e.g., heart rate, movement intensity) during the action period, timestamps events, and computes intermediate metrics (e.g., duration, step count, heart rate change), and outputs execution status data back to the server.

### Step 15:

Server records execution status and computes execution result information.

Server receives execution status data and any completion indicators from the terminal.

Input: timestamps, completion flag, duration, steps, and sensor-based changes (e.g., heart rate before and after intervention).

Server determines whether the user completed the recommended solution, calculates a completion rate and continuation rate over time, and stores these values along with raw execution logs.

Server aggregates data into execution result information that includes objective measures (completion, duration, physiological changes) and prepares to link them to corresponding prompts and solutions.

### Step 16:

Server acquires subjective evaluation and completes execution result information.

Server instructs the terminal to show a feedback UI, asking the user to rate helpfulness or to provide a short comment.

User enters a rating (e.g., 4 out of 5) or text feedback, such as “I feel a bit more relaxed now.” Terminal sends this feedback to the server.

Input: rating value and optional feedback text.

Server attaches the subjective evaluation to the execution logs, forming complete execution result information including completion rate, continuation rate, evaluation value, and emotion-related comments, and outputs this as a record into the results table.

### Step 17:

Server analyzes execution results and updates prompt and ranking parameters.

Server reads the execution result information along with the prompt sentence, generative AI output, and selected solution candidate used for that interaction.

Input: linked records comprising context information, prompt sentence, AI output, chosen candidate, and execution results.

Server computes statistics such as average rating per prompt template, per solution type, and per emotion state, and identifies patterns, for example that short, concrete prompts yield higher completion for stressed states.

Server updates internal parameters controlling prompt construction (e.g., preferred template selection probabilities, default length, style constraints) and adjusts weights in the suitability scoring function for solution candidates, and outputs an updated configuration that will be used in future interactions.

### Step 18:

Server maintains and optimizes the generative AI workflow over time.

Server periodically retrains or fine-tunes the generative AI model or associated classifiers using accumulated interaction data, subject to system design.

Input: historical prompt-response pairs, context features, and execution outcomes.

Server uses these data to adjust model parameters via gradient-based optimization with loss functions that reflect not only prediction accuracy but also downstream success metrics, such as completion and satisfaction.

Server produces updated model weights and refined prompt generation rules, and stores them for subsequent inference, thereby continuously improving the quality and technical efficiency of the generative AI model and the prompt sentence pipeline.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

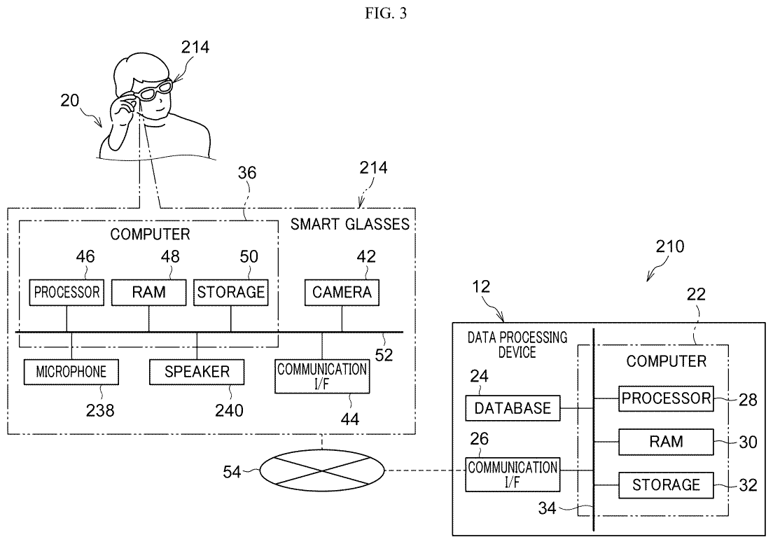

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

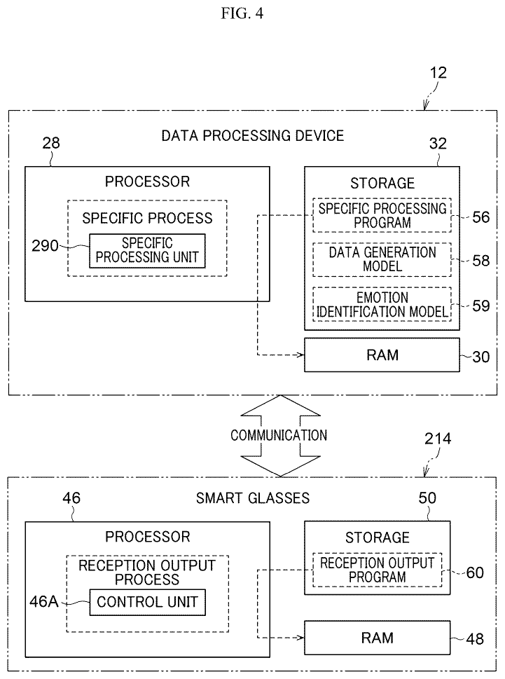

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

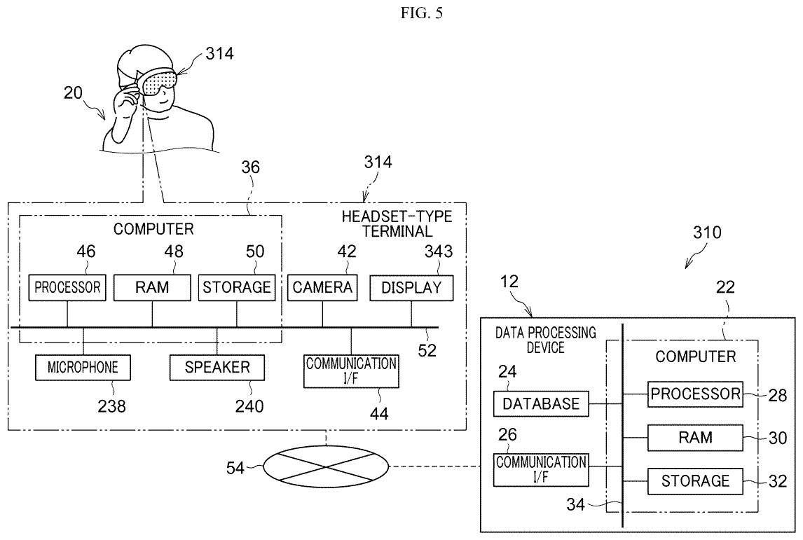

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

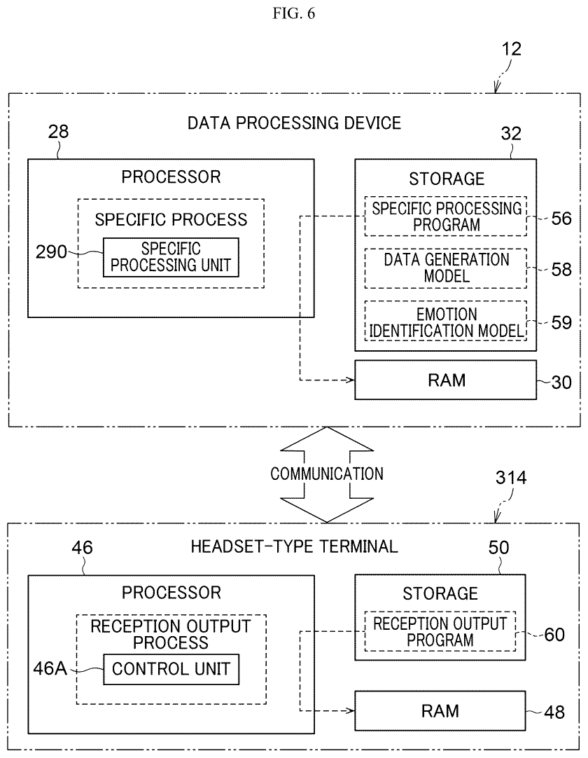

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

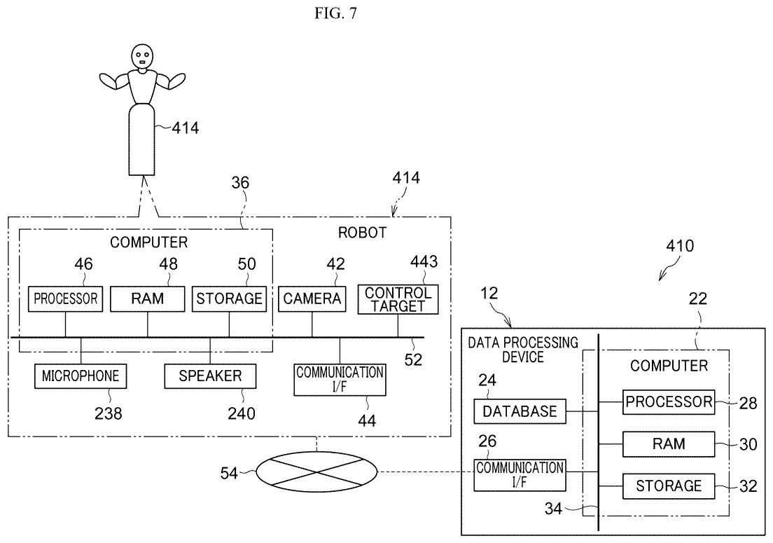

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

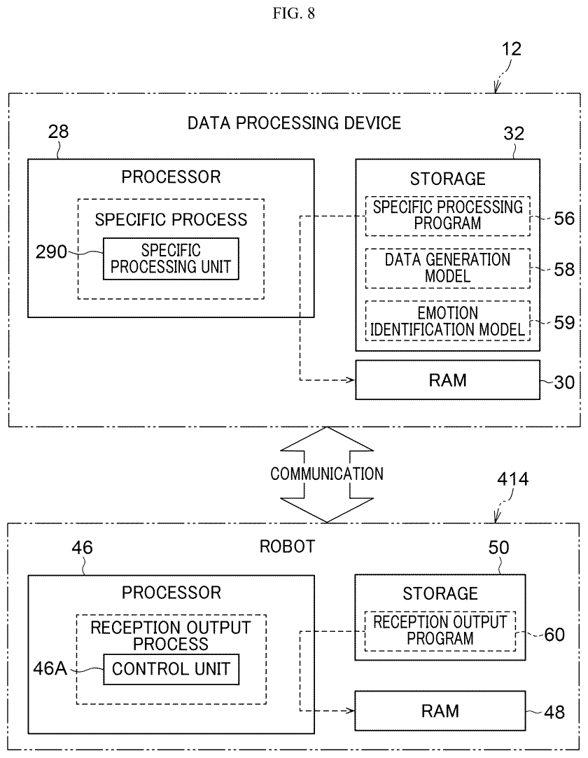

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

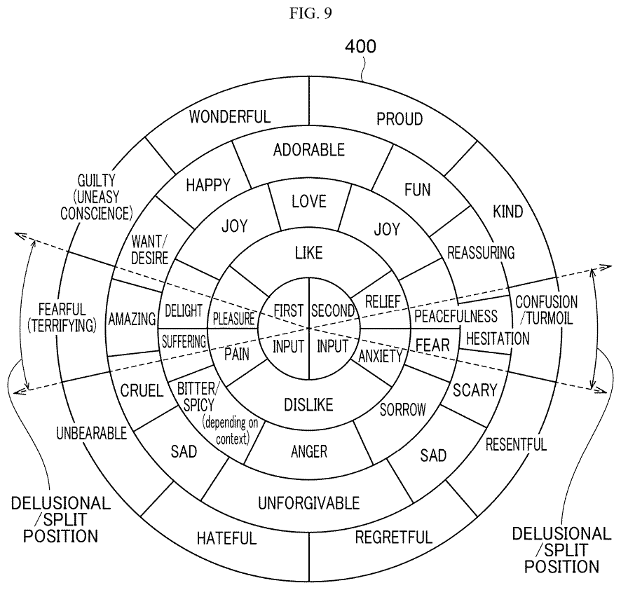

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

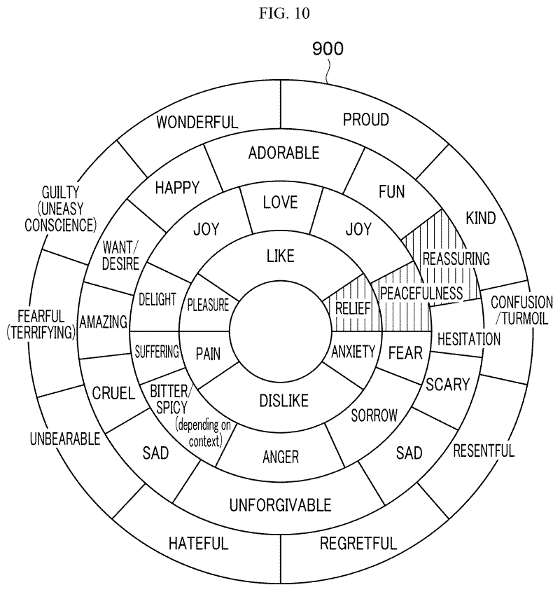

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, by using an information acquisition device and a communication control device, behavior information and utterance information of a user, the behavior information and the utterance information including state information, audio information, image information, and character information from a user terminal, and including posting information obtained from an external information providing device via an information providing communication scheme,
preprocess the acquired information by converting the audio information into the character information using a speech recognition processing device, extracting, from the image information, feature amounts indicating expression information and posture information using an image processing device and a feature amount extraction device, performing removal of unnecessary information and division into word units on the character information and the posting information using a character string formatting device and a language processing device, and integrating the behavior information, the utterance information, and the posting information based on time-series information to generate integrated event information for each user,
generate a first prompt sentence for a semantic analysis language model based on the character information included in the integrated event information, input the first prompt sentence into a generative information processing model to obtain emotion information and intention information, input the feature amounts and the state information into a discrimination model to obtain expression state information and behavior state information, and integrate the emotion information, the intention information, the expression state information, and the behavior state information by using an information integration device, thereby estimating and determining concern information, problem information, and desire information of the user,
generate a second prompt sentence for advice information generation based on the estimated and determined concern information, problem information, and desire information, input the second prompt sentence into the generative information processing model, and generate response information including solution information individually optimized for each user, and
transmit the response information to the user terminal via a notification communication device, cause display of the solution information through a display control device, and record a presentation result and selection operation information of the user as behavior history information.

### Supplementary 2

The system according to supplementary 1,
wherein the processor is configured to
sequentially update contents and structures of the first prompt sentence and the second prompt sentence to be input into the generative information processing model based on the behavior history information and the integrated event information, and adaptively control the second prompt sentence such that the solution information reflects long-term state changes of each user.

### Supplementary 3

The system according to supplementary 1,
wherein the processor is configured to
store the integrated event information, the emotion information, the intention information, the expression state information, and the behavior state information as time-series data in a storage device, execute a learning process for learning state transition information of the user by using the time-series data, and update weighting and threshold values used in estimation and determination processing of the concern information, the problem information, and the desire information and in generation processing of the solution information based on a result of the learning process.

### Application Example 1

### Supplementary 1

A system comprising a processor,
wherein the processor is configured to
acquire, by using a detection apparatus and an audio acquisition apparatus, information regarding behavior of a user and information regarding audio of the user as time-series data, and perform preprocessing of the time-series data through digital signal processing and statistical processing to generate feature data, and
input character string data obtained from the information regarding the audio and the feature data to a machine learning model, and calculate an estimation result indicating a concern, a problem, or a desire of the user, and
refer to an information storage apparatus in which the estimation result and item information or service information are stored in association with each other, extract candidate information corresponding to the estimation result, and determine recommendation target information, and
generate a prompt sentence based on the estimation result and the recommendation target information, input the prompt sentence to a generative artificial intelligence model, and thereby cause the generative artificial intelligence model to generate explanation text information or proposal text information to be presented to the user, and
generate notification information including the explanation text information or the proposal text information and the recommendation target information, and transmit the notification information to a user terminal via a communication apparatus, and
acquire selection information or operation information of the user with respect to the notification information received by the user terminal, and record the selection information or the operation information in association with the estimation result and the recommendation target information, and
update the machine learning model or a generation method of the prompt sentence based on the record.

### Supplementary 2

The system according to supplementary 1,
wherein the processor is configured to manage execution processing, reservation processing, or purchase processing relating to the recommendation target information based on the selection information or the operation information of the user with respect to the notification information, generate support information corresponding to a management result as the prompt sentence for the generative artificial intelligence model, input the support information to the generative artificial intelligence model, and thereby cause the generative artificial intelligence model to generate support explanation text information including an execution procedure of a solution, a usage method, or follow-up information, and transmit the support explanation text information to the user terminal.

### Supplementary 3

The system according to supplementary 1,
wherein the processor is configured to acquire a transmission history of the notification information, the selection information or the operation information of the user, and a viewing status of the support explanation text information, analyze an acquisition result to generate evaluation information indicating a behavior tendency, a preference, or a response tendency of the user, and update training data of the machine learning model or a template of the prompt sentence input to the generative artificial intelligence model based on the evaluation information.

### Example 2

### Supplementary 1

A system comprising a processor, a communication device, and a storage device,
wherein the processor is configured to receive, via the communication device, input information described in natural language from a user through a terminal device, wherein the processor is configured to analyze the input information by using a natural language processing technique and to identify a category of a concern or issue included in the input information and summary information corresponding to the concern or issue,
wherein the processor is configured to issue, based on the identified category and the input information, a search request to the storage device and to acquire, from the storage device, related information classified into at least one field including a health field, an exercise field, and a diet field,
wherein the processor is configured to generate a prompt sentence including the input information and the acquired related information, and to input the prompt sentence to a generative artificial intelligence model so as to cause the generative artificial intelligence model to generate a solution candidate for the user, and
wherein the processor is configured to transmit the solution candidate acquired from the generative artificial intelligence model to the terminal device via the communication device so that the solution candidate is presented to the user.

### Supplementary 2

The system according to supplementary 1,
wherein the processor is configured to generate a first prompt sentence for analysis of the input information and a second prompt sentence for generation of the solution candidate based on the related information, the first prompt sentence and the second prompt sentence being different from each other, and to cause the generative artificial intelligence model to perform respective generation processes based on the first prompt sentence and the second prompt sentence.

### Supplementary 3

The system according to supplementary 1,
wherein the processor is configured, when additional input information is received from the user through the terminal device via the communication device, to input the additional input information again into a processing flow using the natural language processing technique and the storage device, to update the prompt sentence for the generative artificial intelligence model based on the additional input information, and to iteratively improve the solution candidate generated by the generative artificial intelligence model.

### Application Example 2

### Supplementary 1

A system comprising a processor,
wherein the processor is configured to
acquire time-series data from multiple types of sensor devices and terminal devices in order to obtain behavior information, utterance information, biological information, and environmental information of a user, and
perform preprocessing and normalization on the acquired time-series data to calculate, for each unit time, an activity amount, a movement distance, a heart rate, an energy expenditure amount, an emotion estimation result, and a health indicator, and to generate feature information representing a state of the user, and
execute natural language processing on input text information or speech recognition results of the user and on the feature information, the natural language processing including at least morphological analysis, syntactic analysis, emotion analysis, and topic extraction, so as to extract keyword information and category information related to concerns, issues, and desires of the user, and
generate, based on the feature information, the category information, and a result of the emotion analysis, context information, and automatically generate a prompt sentence defining at least a task content, an output format, and a constraint condition on the basis of the context information, and input the prompt sentence into a generative artificial intelligence model, and obtain text information output from the generative artificial intelligence model, estimate and determine the concerns and the issues of the user based on the text information, and, according to types of the concerns and the issues, search a solution candidate database stored in a data storage device to extract solution candidates, calculate suitability degrees of the solution candidates based on attribute values of the solution candidates and the feature information, and select at least one of the solution candidates, and
edit the selected solution candidate into a presentation format suitable for the user and present the edited solution candidate to the user via the terminal device, and
acquire, from the terminal device, execution status and subjective evaluation by the user with respect to the selected solution candidate, record the execution status and the subjective evaluation as execution result information including at least a completion rate, a continuation rate, and an evaluation value, and update the feature information and generation conditions of the prompt sentence based on the execution result information so as to optimize, for subsequent processing, contents of input to the generative artificial intelligence model.

### Supplementary 2

The system according to supplementary 1,
wherein the processor is configured to
generate, based on the text information obtained from the generative artificial intelligence model and on the selected solution candidate, a concrete action plan including at least one of a health management menu, a physical activity program, and a psychological burden reduction method, and, by cooperating with a provision management apparatus including at least one of a distribution management apparatus and a service provision management apparatus, manage a provision status of a good or a service relating to the action plan and notify the user of the provision status in real time.

### Supplementary 3

The system according to supplementary 1,
wherein the processor is configured to
accumulate a correspondence relationship among behavior records of the user, changes in an emotional state of the user, the prompt sentence, and an output of the generative artificial intelligence model, statistically evaluate and update components, instruction contents, and constraint conditions of the prompt sentence based on the correspondence relationship, and thereby continuously improve suitability and effectiveness of solutions output from the generative artificial intelligence model.

What is claimed is:

1. A system comprising:
circuitry configured to:
receive, via a packet-switched network, a plurality of data streams from a terminal device, the plurality of data streams comprising at least sensor-derived activity data and character string data associated with a user of the terminal device;
perform preprocessing on the plurality of data streams by executing automatic speech recognition on audio signal data included in the plurality of data streams to produce transcribed character string data, executing a convolutional neural network on image frame data included in the plurality of data streams to extract feature vectors from a penultimate layer of the convolutional neural network, and applying tokenization and linguistic normalization to the character string data and the transcribed character string data to produce token sequences;
generate integrated event records for the user by temporally aligning the sensor-derived activity data, the token sequences, the feature vectors, and posting data retrieved from an external information processing apparatus via the packet-switched network, each integrated event record comprising references to data elements observed within a defined temporal interval;
construct a first structured prompt for a generative neural network model by inserting the token sequences and contextual metadata derived from a selected integrated event record into a predefined template, transmit the first structured prompt to an information processing apparatus hosting the generative neural network model, and parse an output token sequence received from the generative neural network model to extract semantic label data and categorical descriptor data;
execute a forward inference pass through a discrimination neural network comprising a plurality of fully connected layers with non-linear activation functions, using the feature vectors and state data derived from the sensor-derived activity data as input, to produce first classification output data and second classification output data;
map the semantic label data, the categorical descriptor data, the first classification output data, and the second classification output data into a common embedding space as respective numeric vectors and compute a weighted combination vector by applying adaptive weight parameters to the respective numeric vectors, and apply a decision function to the weighted combination vector to produce estimation result data;
construct a second structured prompt for the generative neural network model by embedding the estimation result data and constraint parameters into a solution generation template, transmit the second structured prompt to the information processing apparatus, and receive generated response data comprising structured output data individually computed for the user;
transmit the generated response data to the terminal device via the packet-switched network to cause rendering of the structured output data on a display of the terminal device, and record selection operation data received from the terminal device as interaction log data;
update contents and structure of the first structured prompt and the second structured prompt based on the interaction log data and accumulated integrated event records such that the structured output data reflects longitudinal state changes of the user; and
store the integrated event records, the semantic label data, the categorical descriptor data, the first classification output data, and the second classification output data as time-series data, execute a learning process using a recurrent neural network that receives sequences of weighted combination vectors and predicts subsequent state vectors, and update the adaptive weight parameters and threshold values used in the decision function based on a result of the learning process.

2. The system according to claim 1, wherein the circuitry is further configured to:
acquire the posting data from the external information processing apparatus by issuing an application programming interface request to a network service, the posting data comprising text content, timestamp data, and reaction count data, and store the posting data in a storage device in a unified schema distinguishing among the sensor-derived activity data, the character string data, the image frame data, the audio signal data, and the posting data.

3. The system according to claim 2, wherein the circuitry is further configured to:
execute the automatic speech recognition using a deep neural network comprising a convolutional front-end, a bidirectional recurrent network, and a connectionist temporal classification loss function, the circuitry feeding time-frequency representations of the audio signal data into the deep neural network and obtaining the transcribed character string data with associated confidence score values.

4. The system according to claim 3, wherein the circuitry is further configured to:
apply an additional classification layer to the feature vectors extracted by the convolutional neural network to map the feature vectors to expression state categories comprising at least a fatigue category, a stress category, a neutral category, and an energetic category, and estimate continuous expression intensity values associated with each expression state category.

5. The system according to claim 4, wherein the estimation result data comprises concern information identifying an inferred area of worry of the user, problem information identifying a specific difficulty of the user, and desire information identifying a goal or objective of the user, the concern information, the problem information, and the desire information being derived from application of the decision function to the weighted combination vector.

6. The system according to claim 5, wherein the structured output data comprises solution information individually optimized for the user including at least a title, a plurality of suggested action items, and a motivational message, the circuitry transmitting the solution information to the terminal device for presentation in a structured layout.

7. The system according to claim 6, wherein the circuitry is further configured to:
when additional character string data is received from the terminal device via the packet-switched network, re-apply the tokenization and the linguistic normalization to the additional character string data, identify modification constraints derived from the additional character string data, issue a search request to a storage device to retrieve updated related information satisfying the modification constraints, and construct an updated second structured prompt incorporating the modification constraints and the updated related information.

8. The system according to claim 7, wherein the circuitry is further configured to:
issue, based on a category identified from the estimation result data, a search request to the storage device and acquire from the storage device related information classified into at least one field including a health field, an exercise field, and a diet field, and incorporate the related information into the second structured prompt.

9. The system according to claim 1, wherein the generative neural network model comprises a transformer-based decoder network trained on a text corpus using supervised learning with a cross-entropy loss function and backpropagation, the circuitry applying beam search or sampling with a configured temperature parameter and maximum output token length to generate tokens of the generated response data.

10. The system according to claim 9, wherein the circuitry is further configured to:
employ streaming output by transmitting partial output tokens from the generative neural network model to the terminal device via the packet-switched network using buffer size thresholds and timing parameters, such that the terminal device begins rendering portions of the structured output data while remaining tokens are still being generated.

11. The system according to claim 1, wherein the recurrent neural network comprises a long short-term memory network that receives the sequences of weighted combination vectors and predicts future state vectors or categorical assignments, the circuitry training the long short-term memory network by minimizing a loss function between predicted and observed state transitions using gradient computation and weight update operations.

12. The system according to claim 11, wherein the circuitry is further configured to:
analyze correlation between previous structured prompts, output data generated by the generative neural network model, the interaction log data, and subsequent user state data derived from later integrated event records, and adjust prompt templates, parameter values, and level of detail in the first structured prompt and the second structured prompt based on the analyzed correlation.

13. The system according to claim 12, wherein the circuitry is further configured to:
detect that a shorter and more directive structured prompt yields more stable output data and higher interaction frequency indicated in the interaction log data, and in response modify the predefined template and the solution generation template to reduce token length of subsequent structured prompts.

14. The system according to claim 1, wherein the circuitry is further configured to:
perform part-of-speech tagging and lemmatization on the token sequences, and store cleaned and tokenized character information in a structured representation comprising token sequences, sentence boundaries, and linguistic annotation data.

15. The system according to claim 14, wherein the circuitry is further configured to:
when generating the integrated event records, group temporally aligned data elements into event windows of a defined duration, each event window comprising aggregated state information including average motion level, device usage pattern data, and detected expression state category data.

16. The system according to claim 15, wherein the circuitry is further configured to:
maintain a rule module that checks category-specific safety constraints on the generated response data before transmitting the generated response data to the terminal device, and when a constraint violation is detected, modify the second structured prompt to impose additional restrictions and retransmit the modified second structured prompt to the information processing apparatus to obtain regenerated response data.

17. The system according to claim 1, wherein the discrimination neural network comprises a feed-forward neural network trained using labeled feature vector data and known classification categories by minimizing a cross-entropy classification loss through backpropagation, and the circuitry uses the trained discrimination neural network at inference time to assign the first classification output data and the second classification output data to the feature vectors and the state data.

18. A system comprising:
circuitry configured to:
receive, via a packet-switched network, a plurality of data streams from a terminal device, the plurality of data streams comprising sensor-derived activity data, audio signal data, image frame data, and character string data, and retrieve posting data from an external information processing apparatus via the packet-switched network;
perform preprocessing on the plurality of data streams by executing automatic speech recognition on the audio signal data to produce transcribed character string data, executing a convolutional neural network on the image frame data to extract feature vectors, applying tokenization and linguistic normalization to the character string data, the transcribed character string data, and the posting data to produce token sequences, and performing part-of-speech tagging and lemmatization on the token sequences;
generate integrated event records by temporally aligning the sensor-derived activity data, the token sequences, the feature vectors, and the posting data within defined temporal intervals;
construct a first structured prompt by inserting the token sequences derived from a selected integrated event record into a predefined template, transmit the first structured prompt to an information processing apparatus hosting a generative neural network model, and parse an output token sequence to extract semantic label data and categorical descriptor data;
execute a forward inference pass through a discrimination neural network using the feature vectors and state data to produce first classification output data and second classification output data;
map the semantic label data, the categorical descriptor data, the first classification output data, and the second classification output data into a common embedding space as numeric vectors, compute a weighted combination vector using adaptive weight parameters, and apply a decision function to produce estimation result data comprising concern information, problem information, and desire information of the user;
construct a second structured prompt by embedding the estimation result data into a solution generation template, transmit the second structured prompt to the information processing apparatus, and receive generated response data comprising solution information;
transmit the generated response data to the terminal device via the packet-switched network to cause rendering of the solution information on a display of the terminal device, and record selection operation data as interaction log data;
update the first structured prompt and the second structured prompt based on the interaction log data and the integrated event records; and
store the semantic label data, the categorical descriptor data, the first classification output data, the second classification output data, and the weighted combination vectors as time-series data, execute a learning process using a recurrent neural network to predict state transitions, and update the adaptive weight parameters and threshold values based on the learning process.

19. The system according to claim 18, wherein the circuitry is further configured to:
when additional character string data is received from the terminal device, re-apply the tokenization and linguistic normalization, identify modification constraints, issue a search request to a storage device to retrieve updated related information classified into at least one of a health field, an exercise field, or a diet field, and construct an updated second structured prompt incorporating the modification constraints and the updated related information to cause the generative neural network model to generate an improved solution candidate.

20. A method performed by circuitry, the method comprising:
receiving, via a packet-switched network, a plurality of data streams from a terminal device, the plurality of data streams comprising at least sensor-derived activity data and character string data associated with a user of the terminal device;
performing preprocessing on the plurality of data streams by executing automatic speech recognition on audio signal data included in the plurality of data streams to produce transcribed character string data, executing a convolutional neural network on image frame data included in the plurality of data streams to extract feature vectors, and applying tokenization and linguistic normalization to the character string data and the transcribed character string data to produce token sequences;
generating integrated event records for the user by temporally aligning the sensor-derived activity data, the token sequences, the feature vectors, and posting data retrieved from an external information processing apparatus via the packet-switched network;
constructing a first structured prompt for a generative neural network model by inserting the token sequences and contextual metadata derived from a selected integrated event record into a predefined template, transmitting the first structured prompt to an information processing apparatus hosting the generative neural network model, and parsing an output token sequence received from the generative neural network model to extract semantic label data and categorical descriptor data;
executing a forward inference pass through a discrimination neural network comprising a plurality of fully connected layers with non-linear activation functions, using the feature vectors and state data as input, to produce first classification output data and second classification output data;
mapping the semantic label data, the categorical descriptor data, the first classification output data, and the second classification output data into a common embedding space as respective numeric vectors and computing a weighted combination vector by applying adaptive weight parameters to the respective numeric vectors, and applying a decision function to the weighted combination vector to produce estimation result data;
constructing a second structured prompt for the generative neural network model by embedding the estimation result data and constraint parameters into a solution generation template, transmitting the second structured prompt to the information processing apparatus, and receiving generated response data comprising structured output data individually computed for the user;
transmitting the generated response data to the terminal device via the packet-switched network to cause rendering of the structured output data on a display of the terminal device, and recording selection operation data received from the terminal device as interaction log data;
updating contents and structure of the first structured prompt and the second structured prompt based on the interaction log data and accumulated integrated event records; and
storing the integrated event records, the semantic label data, the categorical descriptor data, the first classification output data, and the second classification output data as time-series data, executing a learning process using a recurrent neural network that receives sequences of weighted combination vectors and predicts subsequent state vectors, and updating the adaptive weight parameters and threshold values used in the decision function based on a result of the learning process.
